(19) United States
(12) Patent Application Publication
(10) Pub. No.: US 2011/0167071 A1
(43) Pub. Date: Jul. 7, 2011

(54) METHOD FOR SCORING INDIVIDUAL NETWORK COMPETITIVENESS AND NETWORK EFFECT IN AN ONLINE SOCIAL NETWORK

(75) Inventor: Yu-Sok YANG, Seoul (KR)

(73) Assignee: O WAVE MEDIA CO., LTD., Seoul (KR)

(21) Appl. No.: 12/985,067

(22) Filed: Jan. 5, 2011

(30) Foreign Application Priority Data
Jan. 5, 2010 (KR) 10-2010-0000465

(51) Int. Cl. G06F 17/30

(52) U.S. Cl. 707/741; 707/E17.002

(57) ABSTRACT

The present invention relates to a method for scoring individual network competitiveness and network effect by network analysis in an online social network, particularly, to embody a social network in an online way, to measure network competitiveness and network effect of each node in an online social network based on results of mutual evaluation for trust, integrity, solidarity, openness, importance, and intimacy among the 1^{st} ties related nodes in a social network, and to give information value to nodes and ties of networks.

### TECHNICAL FIELD

The present invention relates to an online social network, more particularly, a method for scoring individual network competitiveness and network effect in an online social network for measuring competitiveness, network effect, network competitiveness, social rank of each individual upon providing social networking service (SNS) and scoring individual network competitiveness and network effect which give information value between nodes and ties of a network with embodying a social network in an online way and analyzing a network.

### BACKGROUND

The Internet influencing our normal life has been overwhelmingly changed and online social networking service has functioned as a new foundation of meetings. Many people have recombined their friends, neighborhoods, communities, and societies into themselves by using an online social network.

Influencing most parts of our normal life, such online social networks helps to directly connect to other people who have similar ways of thinking and to form a partnership with more people by much more ways than ever.

While diverse social networking services are currently provided, membership is classified into invitation types and openness types and joining membership is available for everyone because openness is mostly selected. Accordingly, the quality of members has fallen off. Also, major problems have been occurred in relation to truth and trust of networks by the structure in which the social connection network is expanded by approvals of requests for simple online friends. For example, as for “MYSPACE”, the famous social networking service in America, approximately 7,000 databases of doubtful members were deleted by matching databases of suspected criminals in 2007, and 90,000 sex criminals lost their membership privilege in 2009. As for “www.fakemyspace.com”, it comes to social attention that problems related to truth and trust of networks are generated because pay services for expanding friends in response to demand of members are provided. Further, the problem is that the network in all social networking services is expanded by an online human network; non-information on nodes and ties forms a simple undifferentiated network; social problems are incurred by the lack of truth and trust; and it is hard to develop services and profit structure.

To solve such problems, the applicant of the present invention filed Korean Patent No. 10-0933995 (System and method for measuring social capital index in an online social network, the date of registration: 2009.12.17) for measuring social capital index in an online social network, enabling to index and measure social capital which indicates competitive power among individuals by mutual evaluation performed among the human network after members of the social networking services establish the human connection by requesting and approving agreement of human relationship, and to create a basis for providing innovative services with network analysis by obtaining asymmetric information constituting a link between nodes of the social connection network.

FIG. 1 is a schematic drawing representing the structure of the system for scoring social capital index in an online social network.

Referring to FIG. 1, the system for scoring social capital index in an online social network (100) consists of: a client computer (110) which indicates a terminal which enables a member to connect to the homepage of an application server (130), to be explained below, through a wire and wireless communication network; social network database (120) comprising member information database (121) to which each member's personal information including ID, name(s), email address(es), telephone number(s), job(s), work area(s), address(es), nation(s), and school(s) is stored; and human network database (123) storing valuation scores, individual item index, and social capital index among the human relation with member ID as a key while member ID and the member ID of human relation are respectively stored in order to check the member ID that is in the human relation with members on a basis of a social network; and an application server (130) for providing valuation service that inter-evaluates social capital index of the human network when each member logs in on a homepage through a wire and wireless Internet network by using the client computer (110) and storing individual item index and social capital index of the human network to the social network database (120) after providing members in the human network with a valuation item fill-out applet for scoring social capital index when the valuation service is selected and after scoring the individual item index and social capital index of the human network by using each valuation mark inputted through the valuation item fill-out applet.

The method for measuring social-capital index in an online social network establishes the human network after a member logs in on the homepage of the application server (130).

Then, the above method provides the valuation service that may inter-evaluate the social capital index of the human network in the application server (130) when the human network is established, and provides the valuation item fill-out applet for measuring the social capital index for each member of the human network in the application server (130) when the valuation service is selected by members.

Then, the above method stores the individual item index of the human network and the social capital index to the human network information database (123) after measuring the individual item index and the social capital index of the human network by using each valuation score in the application server (130) when each valuation score is inputted by the valuation item fill-out applet; provides the valuation item applet when revaluation service is selected so that a member can correct the social capital index of the human network; renew and stores the individual item index of the human network and the social capital index to the human network information database (123) after measuring the individual item index of the human network and the social capital index by using each valuation score checked by the valuation item applet.

Then, the above method measures the social capital index toward the whole or partial social networks by using the individual item index and the social capital index stored in the human network information database (123) of the social network database (120) in the application server (130).

In such method for measuring the social capital index, social capital, which is competitiveness among individuals, is measured and expressed as information on ties, which indicates a connection between nodes and nodes. However, the modern society currently requires information on individual competitiveness, network competitiveness and social rank.

Although problems in modern society are getting changed complicatedly more and more and companies try to employ manpower who can solve complex problems, the reality is that it is difficult to respond to problems only with personal knowledge and network having various knowledge in many different fields should be utilized to solve problems. Therefore, the society is being changed with requiring network competitiveness.

Meanwhile, recently in America, when recruiting, “FACEBOOK” website checks profiles of jobseekers. Also, “BEST BUY” announces in a job opening for experienced employees that the qualification of applicants is more than 250 followers in Twitter. It considers marketing effects followed by the service structure of Twitter, but there is a problem that simple level of network competitiveness is provided in such service.

### PROBLEMS THAT INVENTION SOLVES

To solve the above problems, the object of the present invention is to provide a method for scoring individual network competitiveness and network effect in an online social network for measuring competitiveness, network effect, network competitiveness, social rank of each individual upon providing social networking service(SNS) with embodying a social network in an online way and analyzing network.

The another object of the present invention is to provide a method for scoring individual network competitiveness and network effect in an online social network for diversifying services, maximizing competitiveness and creating profit structure by giving information value to nodes and ties of network infrastructure.

### TECHNICAL PROBLEM

To accomplish the above object, the present invention is characterized by the method for scoring network competitiveness and network effect of each node in an online social network based on results of mutual evaluation for trust, integrity, solidarity, openness, importance, and intimacy among 1^{st} ties related nodes in an online social network, comprising: individual index derivation process of deriving individual indexes, which consist of trust index (TI), integrity index (II), solidarity index (SI), openness index (OI), importance index (IMI) and intimacy index (INI) quantifying the level of trust, integrity, solidarity, openness and importance among 1^{st} tie related nodes, for ties of each node by using the results of mutual evaluation; social capital index derivation process of deriving social capital index (SCI), quantifying the level of social capital among 1^{st} ties related nodes, for ties of each node by using the results of mutual evaluation; social capital evaluation index derivation process of deriving social capital evaluation index (SEI), quantifying the level of mutual evaluation among 1^{st} ties related nodes, for ties of each node by using the results of mutual evaluation; competitiveness transfer potential factor derivation process of deriving competitiveness transfer potential factor(α), quantifying the potential level of transferring competitiveness of 1^{st} ties related node to an arbitrary node, for ties of each node by using the level of evaluation for importance index and intimacy index among individual indexes by the results of mutual evaluation; individual competitiveness derivation process of deriving individual competitiveness(nc⁰i), quantifying competitiveness of each individual, for each node by using the social capital index; transfer potential competitiveness derivation process of deriving transfer potential competitiveness(Ci), quantifying the level of competitiveness transferring from a 1^{st} ties related node to an arbitrary node, for ties of each node by using the competitiveness transfer potential factor and the individual competitiveness; transfer competitiveness derivation process of deriving transfer competitiveness(ci), quantifying competitiveness actually transferring from a 1^{st} ties related node to an arbitrary node, for ties of each node by using social capital index or social capital evaluation index, competitiveness transfer potential factor and individual competitiveness; network effect derivation process of deriving network effect(neⁿi), quantifying competitiveness that is consecutively transferred from a 1^{st} ties related node to an arbitrary node through a network by interaction among 1^{st} ties related nodes with each node, by using the social capital index from an arbitrary node to 1^{st}˜n^{th} ties related nodes or social capital evaluation index, competitiveness transfer potential factor and individual competitiveness; and network competitiveness derivation process of deriving competitiveness, cause by network effect of an arbitrary node, by using the social capital index from an arbitrary node to 1^{st}˜n^{th} ties related nodes or social capital evaluation index, competitiveness transfer potential factor, individual competitiveness, transfer potential competitiveness, transfer competitiveness and network effect.

Hereinafter, the individual index is expressed in terms of trust index, integrity index, solidarity index, openness index, importance index and intimacy index, which are corresponded for each tie between an arbitrary node and a 1^{st} ties related node, by measuring the level of individual items by mutual evaluation for each item of trust, integrity, solidarity, openness, importance and intimacy among 1^{st} ties related nodes in a social network.

Further, the mutual evaluation estimates will, ability and standards of evaluators toward evaluatees for each item of trust, integrity, solidarity, openness, importance and intimacy among 1^{st} ties related nodes in social network.

Furthermore, the social capital index refers to a symmetrical value which is constant for each tie between an arbitrary node and a 1^{st} ties related node, adding and calculating all individual indexes and weights after calculating each individual index by mutual evaluation for each item of individual indexes among 1^{st} ties related nodes and applying weights in a social network.

Furthermore, the social capital evaluation index refers to a bidirectional asymmetric value for each tie between an arbitrary node and a 1^{st} ties related node, calculating one index for each evaluator after applying weights to the level of evaluation of evaluators for each item of individual indexes among 1^{st} ties related nodes and adding weights and individual indexes in a social network.

Furthermore, the competitiveness transfer potential factor refers to a bidirectional asymmetric value for each tie between an arbitrary node and a 1^{st} ties related node, calculating one index for each evaluator after adding all levels of evaluation of evaluators for importance index and intimacy index among individual indexes among 1^{st} ties related nodes in a social network.

Furthermore, the individual competitiveness refers to socio-capitalization(cap i) adding all social capital indexes of 1^{st} ties related nodes for each node in a social network, or total competitiveness(tot Ci) further adding any one or more index selected among globalization index, celebrity index, social broker index to the socio-capitalization.

Furthermore, the globalization index, the celebrity index and the social broker index respectively refer to a value calculated by using the number and relation of nodes having other nationalities among arbitrary nodes and connected nodes; a value calculated by using the level which is estimated as celebrities by arbitrary nodes and connected nodes; and a value calculated by using the number of cases, performance and evaluation in which arbitrary nodes broker Needs of a social network.

Furthermore, the transfer potential competitiveness refers to a value multiplying individual competitiveness from arbitrary nodes, object of calculation object of network competitiveness, to 1^{st} ties related nodes by competitiveness transfer potential factor whose direction is competitiveness transfer.

Furthermore, the transfer competitiveness refers to a value multiplying individual competitiveness from arbitrary nodes, calculation objects of network competitiveness, to 1^{st} ties related nodes by competitiveness transfer potential factor whose direction is competitiveness transfer and multiplying this value by social capital index or social capital evaluation index whose direction is competitiveness transfer.

Furthermore, if the above competitiveness is transferred among 1^{st} ties related nodes in a social network, the competitiveness from arbitrary nodes, calculation objects of network competitiveness, and n^{th} ties related nodes to arbitrary nodes is finally transferred to arbitrary nodes by being consecutively transferred from n^{th} ties related nodes to n−1^{th}, n−2^{th}, . . . nodes via a shortest path; and transfer for each level is estimated by the competitiveness transfer potential factor whose direction is the competitiveness transfer, social capital index or social capital evaluation index.

In addition, the network effect is as below.

$$\begin{matrix}{ne}^{n} i = network effect by {nodes}^{n} of node i \\ = \sum {c}_{{nodes}^{n} \to i}^{n} \\ = \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times \\ \sum ( {SI}_{{nodes}^{3} \to {nodes}^{2}} ( \% ) \times {α}_{{nodes}^{3} \to {nodes}^{2}} ( \% ) \times … \times \\ \sum ( {SI}_{{nodes}^{n - 1} \to {nodes}^{n - 2}} ( \% ) \times {α}_{{nodes}^{n - 1} \to {nodes}^{n - 2}} ( \% ) \times \\ \sum ( {SI}_{{nodes}^{n} \to {nodes}^{n - 1}} ( \% ) \times {α}_{{nodes}^{n} \to {nodes}^{n - 1}} ( \% ) \times \\ {nc}^{0} {nodes}^{n} ) … )\end{matrix}$$

Additionally, the network competitiveness is as below.

$$\begin{matrix}{nc}^{n} i = {nc}^{0} i + {ne}^{1} i + {ne}^{2} i + {ne}^{3} i + … + {ne}^{n} i \\ = {nc}^{0} i + \sum {c}_{{nodes}^{1} \to i}^{1} + \sum {c}_{{nodes}^{2} \to i}^{2} + \\ \sum {c}_{{nodes}^{3} \to i}^{3} + … + \sum {c}_{{nodes}^{n} \to i}^{n} \\ = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \\ \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) ) + \\ \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times \\ \sum ( {SI}_{{nodes}^{3} \to {nodes}^{2}} ( \% ) \times {α}_{{nodes}^{3} \to {nodes}^{2}} ( \% ) \times \\ {nc}^{0} {nodes}^{3} ) ) ) + … + \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times \\ \sum ( {SI}_{{nodes}^{3} \to {nodes}^{2}} ( \% ) \times {α}_{{nodes}^{3} \to {nodes}^{2}} ( \% ) \times … \times \\ \sum ( {SI}_{{nodes}^{n - 1} \to {nodes}^{n - 2}} ( \% ) \times {α}_{{nodes}^{n - 1} \to {nodes}^{n - 2}} ( \% ) \times \\ \sum ( {SI}_{{nodes}^{n} \to {nodes}^{n - 1}} ( \% ) \times {α}_{{nodes}^{n} \to {nodes}^{n - 1}} ( \% ) \times \\ {nc}^{0} {nodes}^{n} ) … )\end{matrix}$$

Furthermore, as for the network effect derivation process or network competitiveness derivation process, if competitiveness of the same node is transferred and increased by expanding a path in the next degree calculation, the network effect having the lowest degree in a network is applied, and nodes already calculated in degree, below n^{th}, upon calculating n^{th} network effect are not included; the biggest network effect among all network effects is applied; and if one of applying the average of all network effect is applied or the competitiveness of the same node is transferred and increased through various paths in the same degree calculation, the biggest network effect among all network effects is applied.

Moreover, the method for scoring individual network competitiveness and network effect in an online social network further comprises the process of scoring network competitiveness and network effect of member nodes and non-member nodes by non-member nodes, which is included to the social network, if a member asks a non-member for human network agreement by email and the non-member accepts the human network agreement.

Furthermore, the method for scoring individual network competitiveness and network effect in an online social network further comprises the social rank giving process of providing users with social rank for each node based on total members (including non-members), nation(s), school(s), work area sex, age(s), social club(s), etc. through member information (including non-members), or providing users with social rank of the corresponding node based on total members, nation(s), school(s), work area(s), sex, age(s), social club(s), etc. through profile information for each node.

Furthermore, the method for scoring individual network competitiveness and network effect in an online social network further comprises the process of providing users with network competitiveness which all adds network competitiveness of each node for total members (including non-members), nation(s), school(s), work area(s), sex, age(s) and social club(s).

### EFFECTS

The method for scoring individual network competitiveness and network effect in an online social network according to the present invention is directed to a network competitiveness analysis algorithm by social network effect, enabling to measure competitiveness, network effect, network competitiveness, social rank of each individual upon providing social networking service (SNS), diversify services, maximize competitiveness and create profit structure by giving information value to nodes and ties of network infrastructure.

Further, according to the present invention, in case that services are provided to each person by measuring network effect, network competitiveness, and social rank of each individual, social costs would be decreased in various range of social activities like recruitment, business, personal exchange, etc. Though one person does not improve his own competitiveness, competitiveness would be improved by network effect to which competitive human networks and various human networks related to social capital are accumulated and then, social capital, which is “space competitiveness”, is collected by needs of each person who tries to make network effect, network competitiveness and social rank higher. Therefore, it causes the decrease of social costs and economic growth by spreading social capital of the whole networks. Also, economic and sociologic research materials may be obtained through analyzing results, analyzed by the algorithm, statistically.

### DETAILED DESCRIPTION OF THE INVENTION

Hereinafter, an explanation of the constitution of the system for scoring individual network competitiveness and network effect in an online social network according to the present invention will be given with reference to the attached drawings.

A detailed explanation on the known functions and configurations related to this invention will be avoided for the brevity of the description. And, the terms as will be mentioned below are used by the functions defined in this invention, which is of course varied in accordance with the intension or rules of a user or operator. Therefore, the definition of the terms should be based upon the contents of the description of the invention.

First, terms and roles used in the present invention are as follows:

A social network indicates social structures of individuals or groups which are called as one or more nodes, connected in particularly mutual dependence, such as friendship, relatives, financial exchange, hatred, sexual relationship, or faith, knowledge and reputation. Nodes mean each individual in the social network, and ties mean connection among each individual in the social network.

Moreover, in the social network, 1^{st} ties indicate human network; the 2^{nd} ties indicate human network of human; and n^{th} ties indicate an arbitrary node and the n^{th} human network.

Moreover, social capital indicates the third-generation capital such as competitiveness among groups, between a group and an individual, and among individuals; social-capital index (SCI) indicates a value which indexes the social capital between two connected nodes through items of trust, integrity, solidarity, openness, importance, and intimacy; trust index (TI) between two connected nodes indicates the will and ability for keeping a promise; integrity index (II) between two connected nodes indicates the will and ability for keeping a principle; solidarity index (SI) between two connected nodes indicates the will and ability for unity; openness index (OI) between two connected nodes indicates the will and capacity for open; importance index (IMI) between two connected nodes indicates the will and capacity for importance; and intimacy index (INI) between two connected nodes indicates the will and capacity for intimacy.

Social capital index (SCI) indicates information on ties which measure and index the social capital between two connected nodes, referring to a bidirectional symmetrical index that indexes six kinds of the will and ability like trust, integrity, solidarity, openness, importance, and intimacy toward evaluatees of evaluators for each tie; and social capital evaluation index (SEI) indicates information on ties which index levels, respectively evaluated by two connected nodes toward six kinds of the will and ability like trust, integrity, solidarity, openness, importance, and intimacy, for measuring the social capital between two connected nodes, referring to bidirectional asymmetric index.

Competitiveness transfer potential factor(α) indicates a coefficient which means the potential level of transfer to ties nodes among individual competitiveness of each node, referring to asymmetric information on ties; socio-capitalization indicates the total amount of social capital that an individual owns, besides 1^{st} tie nodes; individual competitiveness indicates a person's competitiveness, referring to various kinds of competitiveness like competitiveness among human networks, globalization; network competitiveness indicates competitiveness that individual competitiveness is embodied by network effect; network effect indicates the situation in which individual competitiveness in the social network is increased by interaction with 1^{st} tie nodes; and competitiveness transfer indicates the situation in which individual competitiveness is transferred to a 1^{st} tie network along with ties of the social network.

FIG. 2 is a schematic drawing representing the structure of the system for scoring individual network competitiveness and network effect in an online social network according to the present invention.

Referring to FIG. 2, the system for scoring individual network competitiveness and network effect in an online social network according to the present invention is consisted of a client computer (10), social network database (20), an application server (30), and a network effect analysis server (40). At this time, the client computer (10) and the social network database (20) are the same constitution with the client computer (110 in FIG. 1) and the social network database (120 in FIG. 1) in Korean Patent No. 10-0933995, filed by the present applicant.

First, the client computer (10) indicates a terminal which enables a member to connect to the homepage of the application server (30) to be explained through a wire and wireless communication network as below, comprising a desk top, a lap top, a portable multimedia player (PMP), palm top, a smart phone etc.

Further, the social network database (20) consists of: member information database (21) storing members' personal information including ID, name(s), email address(es), sex, telephone number(s), job(s), work area(s), address(es), nation(s), and school(s) of each member; human network information database (23) storing IDs of members and non-members who are related to the 1^{st} ties network along with other members based on the social network, respectively and storing evaluation score with the 1^{st} ties network, individual index for each evaluation item, social capital index, social capital evaluation index, competitiveness transfer potential factor, individual competitiveness, transfer potential competitiveness, transfer competitiveness, network effect and network competitiveness in the key of IDs of members and non-members; and non-member information database (25) storing non-members'personal information including ID, name(s), email address(es), sex, job(s), work area(s) and nation(s) of non-members who accept requests for human network agreement with other members.

Furthermore, the application server(30) refers to a server which controls the overall system, particularly, providing evaluation service that mutually evaluates social capital index toward the 1^{st} ties network when members log in on a homepage through a wire and wireless Internet network by using the client computer (10), and storing evaluation score, individual index for each evaluation item and social capital index to human network information database (23) of social network database (20) after scoring individual index for evaluation item and social capital index with the 1^{st} ties network by using each inputted evaluation score. Meanwhile, the application server (30) may provide evaluation service to members or non-members through mails.

In addition, when the network competitiveness for each node calculated in the network effect analysis server (40), to be explained below, is stored in human network information database (23) of social network database (20), the application server (30) provides social rank for each node based on total members (including non-members), nation(s), school(s), work area sex, age(s), social club(s), etc. through member information (including non-members), or provides social rank of the corresponding node based on total members, nation(s), school(s), work area(s), sex, age(s), social club(s), etc. through profile information for each node.

Moreover, the application server (30) provides the network competitiveness which all adds network competitiveness of each node for total members(non-members), nation(s), school(s), work area(s), sex, age(s) and social club(s) through results calculated in the network effect analysis server (40).

In addition, the network effect analysis server (40) obtains information of particular members or total members through member information database (21) and non-member information database (25) by using evaluation score or evaluation item individual index stored in human network information database (23) of the social network database (20) according to particular events (constant time interval, join and withdrawal of membership, etc.); calculates social capital evaluation index, competitiveness transfer potential index, individual competitiveness, transfer potential competitiveness, transfer competitiveness, network effect and network competitiveness of particular members or total members through the above process; and stores the social capital evaluation index, the competitiveness transfer potential index, the individual competitiveness, the transfer potential competitiveness, the transfer competitiveness, the network effect and the network competitiveness to the human network information database (23). At this time, the network effect analysis server (40) may stores values calculated depending on selection to the member information database (21) and non-member information database (25).

Here, when any node of a member asks a non-member for human network agreement by email and the non-member accepts the human network agreement, the network effect analysis server (40) scores the network competitiveness and the network effect of the arbitrary node and non-member's node by non-member's node which is included to the social network.

Hereinafter, the method for scoring individual network competitiveness and network effect in an online social network according to the present invention is sophisticatedly explained by referring to the enclosed drawings as follows:

FIGS. 3a and 3b are flow charts for explaining the method for scoring individual network competitiveness and network effect in an online social network according to the invention.

Referring to FIG. 3, the method for scoring individual network competitiveness and network effect in an online social network according to the present invention draws separate indexes comprising trust index, integrity index, solidarity index, openness index, importance index, and intimacy index, which measure the will and ability for each of trust, integrity, solidarity, openness, importance and intimacy among 1^{st} tie nodes, for ties of each node by using results of mutual evaluation in the network effect analysis server (40) (S100). Further, the social capital index (SCI) measuring the social capital level among 1^{st} tie nodes is drawn for ties of each node by using results of mutual evaluation in the network effect analysis server (40) (S110).

Furthermore, the social capital evaluation index (SEI) measuring the level of mutual evaluation among 1^{st} tie nodes is drawn for ties of each node by using results of mutual evaluation in the network effect analysis server (40) (S120).

In addition, the competitiveness transfer potential factor(α) for measuring the potential level that competitiveness of the 1^{st} tie node may be transferred to an arbitrary node is drawn for ties of each node by using the importance index and intimacy index among separate indexes by results of mutual evaluation in the network effect analysis server (40) (S130).

Meanwhile, the individual competitiveness (nc⁰i) measuring individual competitiveness of nodes is drawn for each node by using the social capital index in the network effect analysis server (40) (S140).

Also, the transfer potential competitiveness(Ci) measuring the level of competitiveness which is possible to transfer from the 1^{st} tie nodes to an arbitrary node is drawn for ties of each node by using the competitiveness transfer potential factor and the individual competitiveness in the network effect analysis server (40) (S150).

Further, the transfer competitiveness(ci) measuring competitiveness which actually transfers from the 1^{st} tie nodes to an arbitrary node is drawn for ties of each node by using the social capital index or the social capital evaluation index, the competitiveness transfer potential factor and the individual competitiveness in the network effect analysis server (40) (S160).

Furthermore, the network effect (neⁿi) measuring competitiveness which transfers from the 1^{st}˜n^{th} tie nodes to arbitrary nodes through network by interaction among nodes, the relation between each node and the 1^{st} tie nodes, is drawn by using the social capital index or the social capital evaluation index, competitiveness transfer potential factor and the individual competitiveness from arbitrary nodes to the 1^{st}˜n^{th} tie nodes in the network effect analysis server (40) (S170).

Moreover, the network competitiveness(ncⁿi) measuring arbitrary nodes and competitiveness is drawn by using the social capital index or the social capital evaluation index, competitiveness transfer potential factor, the individual competitiveness, transfer potential competitiveness, transfer competitiveness and network effect from arbitrary nodes to the 1^{st}˜n^{th} tie nodes in the network effect analysis server (40) (S180).

Meanwhile, when the network competitiveness for each node calculated in the network effect analysis server (40) is stored in human network information database (23) of social network database (20), the application server (30) provides social rank for each node based on total members (including non-members), nation(s), school(s), work area(s), sex, age(s), social club(s), etc. through the calculated network competitiveness and member information (including non-members), or provides social rank of the corresponding node based on total members, nation(s), school(s), work area(s), sex, age(s), social club(s), etc. through profile information for each node (S190).

Further, the application server (30) may provide the network competitiveness which all adds network competitiveness of each node for total members (including non-members), nation(s), school(s), work area(s), sex, age(s), and social club(s) (S200).

Hereinafter, the process of deriving calculation for calculating social index, competitiveness transfer potential factor, individual competitiveness, transfer potential competitiveness, transfer competitiveness, network effect and network competitiveness in the network effect analysis server (40) of the present invention and the method for scoring individual network competitiveness and network effect in an online social network according to the present invention are sophisticatedly explained as follows:

1. Measuring Individual Network Competitiveness

In society, individual competitiveness is mutually transferred to the constant level of a network depending on characteristics of a network by means of introduction and recommendation of human network, and competitiveness is increased by network effect. Then, individual competitiveness is measured through an online system by embodying social network in an online way and analyzing a network.

Further, as for establishing an online social network, when a member asks a 1^{st} ties related non-member for human network agreement and the non-member accepts the human network agreement, the non-member's node is included in a social network and it may also measure network competitiveness.

2. Social Network and Competitiveness

Society is a network connected to a node and a tie. Also, each node has its own competitiveness; there is intangible competitiveness based on relation in ties which connect each node; and individual competitiveness is mutually transferred, affecting a network throughout 1^{st} ties in society.

In economics, there is space competitiveness (third-generation capital, social capital) among groups, between groups and individuals, and among individuals (Refer to FIG. 4), and its factors such as trust, integrity, solidarity, and openness may be considered to measure social capital, which is competitiveness among people, as information on ties.

3. Network Effect and Network Competitiveness

Generally, if one person \textcircled{1} has many competitiveness human networks, \textcircled{2} accumulates much amount of social capital with people, and \textcircled{3} interchanges with people who obtain competitive human network, individual's network competitiveness is generally much bigger than individual's own competitiveness in accordance with network effect. Meanwhile, an independent individual, who is not joined in a network, is the same as an isolated island, and network effect may not be anticipated.

By separating such network competitiveness for each factor, it may be defined that individual's network competitiveness equals individual competitiveness plus competitiveness of 1^{st}˜the n^{th} ties networks plus competitiveness among networks. Therefore, the network effect depends on competitiveness of 1^{st}˜the n^{th} ties networks and “space competitiveness” of a network for each individual.

In case that nodes are connected to each other in a social network, it is possible to express social capital index by measuring social capital, which is competitiveness between two nodes (Korean Patent No. 10-0933995), and the social capital index may be understood even by cross sections of ties (Refer to FIG. 5). In FIG. 5, “A” and “B” indicate nodes; tie indicates connection of nodes A and B; “social capital” indicates competitiveness between node A and node B; “social capital index” indicates indexation of competitiveness between node A and node B; “a” indicates individual competitiveness of node A; “α_{A→B}” indicates competitiveness transfer potential factor of node A (proportional to interests and will of node A); “Ca” indicates competitiveness transfer potential factor of node A (proportional to α_{A→B}); and “ca” indicates transfer competitiveness of node A by network effect (proportional to social capital index), wherein these are based on a>Ca≧ca.

As shown in FIG. 5, competitiveness in a network is mutually transferred with the 1^{st} ties network via the 1^{st} ties of each node; the whole competitiveness is not transferred due to various reasons like intimacy among individuals, imbalance of Needs information, a lack of time and interests, etc., and the only partial competitiveness may be transferred. Also, the level of competitiveness transfer is limited by features of ties, which are connection paths among nodes.

In addition, since social interchange of people are generated only up to the level of a human network of their human network, the competitiveness of the 2^{nd} ties network commonly affects some particular people via the 1^{st} ties network.

Meanwhile, though individual's competitiveness is transferred to others via a network, it is not reduced.

4. Derivation of Formula for Measuring Network Effect and Network Competitiveness in Social Network

A network is constituted as seen in FIG. 6, consisting 1^{st}, 2^{nd}, 3^{rd} to n^{th} ties, and nodes¹, nodes², nodes³, nodes⁴ to nodesⁿ which mean a network, and a network composed of nodes for each connection step of a network, respectively, wherein “n” is an integer.

Competitiveness for each node is not reduced although it is mutually transferred with an arbitrary node and the 1^{st} ties related nodes¹, and the network competitiveness by network effect may be defined as the amount that individual competitiveness of an arbitrary node is added to competitiveness consecutively transferred from nodes¹, nodes², nodes³, nodes⁴ to nodesⁿ.

4-1. Derivation of Competitiveness Transfer and Formula in Network

Same as FIG. 7, it may be possible to analyze network effect and network competitiveness through mutual transfer of competitiveness in network constituting nodes A-B-C-D and then, the equation for measuring network competitiveness for each node may be derived from the above as follows. At this time, B, C and D indicate A′s nodes¹, A′s nodes² and A′s nodes³, respectively.

### 4-1-1. Condition for Each Node

TABLE 1

| node(/) | A | B | C | D |
|---|---|---|---|---|
| individual | a | b | c | d |
| competitiveness (nc⁰/) | | | | |
| competitiveness | α_{A→B} | α_{B→A} | α_{C→B} | α_{D→C} |
| transfer potential | | α_{B→C} | α_{C→D} | |
| factor among nodes | | | | |
| social index(SI) | SI_{A-B} | SI_{B-A} | SI_{C-B} | SI_{D-C} |
| among nodes | | SI_{B-C} | SI_{C-D} | |
| transfer potential | Ca = α_{A}(%) × | Cb = α_{B}(%) × | Cc = α_{C}(%) × | Cd = α_{D}(%) × |
| competitiveness | a | b | c | d |
| transfer | ca | cb | cc | cd |
| competitiveness | — | =SI_{B-A}(%) × | =SI_{C-B}(%) × | =SI_{D-C}(%) × |
| (mutual transfer with | | α_{B→A}(%) × b | α_{C→B}(%) × c | α_{D→C}(%) × d |
| the 1^{st} ties network, | | = b¹_{B→A} | =c¹_{C→B} | =d¹_{D→C} |
| strong ties, c/) | =SI_{A-B}(%) × | =SI_{B-C}(%) × | = SI_{C-D}(%) × | — |
| | α_{A→B}(%) × a | α_{B→C}(%) × b | α_{C→D}(%) × c | |
| | =a¹_{A→B} | =b¹_{B→C} | =c¹_{C→D} | |

x¹_{1,}: A superscript and a subscript mean the frequency of
transfer and transfer direction for sequence, respectively.

### 4-1-2. Mutual Transfer of the 1^{st} Competitiveness

TABLE 2

| | | node (i) | | | |
|---|---|---|---|---|---|
| | | A | B | C | D |
| individual competitiveness (nc⁰i) | | a | b | c | d |
| transfer competitiveness(i) = mutual | | b¹_{B→A} | a¹_{A→B}, | b¹_{B→C}, | C¹_{C→D} |
| transfer of nc⁰i | | | C¹_{C→B} | d¹_{D→C} | |
| network | competitiveness | a | a¹_{A→B} | — | — |
| competitiveness | competitiveness | b¹_{B→A} | b | b¹_{B→C} | — |
| (nc¹i) | competitiveness | — | C¹_{C→B} | C | C¹_{C→D} |
| | competitiveness | — | — | d¹_{D→C} | d |
| | subtotal | a + b¹_{B→A} | a¹_{A→B} + b + | b¹_{B→C} + C + | C¹_{C→D} + d |
| | | | C¹_{C→B} | d¹_{D→C} | |

Based on the above table 2, the calculation of network competitiveness(nc¹i) of node i is shown in the following mathematical equation 1.

nc¹i=nc⁰i+ne¹i=nc⁰i+Σc¹_{nodes}¹_{→i}

∴nc¹i=nc⁰i+Σ(SI_{nodes}¹ᵢ(%)×C¹nodes¹) [MATHEMATICAL EQUATION 1]

That is, nc¹i equals nc⁰i (individual competitiveness of node i) plus ne¹i (network effect by nodes¹, i.e., competitiveness transferred from the 1^{st} ties network of node i to node i)

### 4-1-3. Mutual Transfer of the 2^{nd} Competitiveness

TABLE 3

| | | node (i) | | | |
|---|---|---|---|---|---|
| | | A | B | C | D |
| individual competitiveness (nc⁰i) | | a | b | c | d |
| transfer | | b¹_{B→A} | a¹_{A→B}, | b¹_{B→C}, | C¹_{C→D} |
| competitiveness (i) = mutual | | | C¹_{C→B} | d¹_{D→C} | |
| transfer of nc⁰i | | | | | |
| transfer | | a²_{A→B/B→A} | b²_{B→A/A→B} | a²_{A→B/B→C} | b²_{B→C/C→D} |
| competitiveness (ii) = mutual | | C²_{C→B/B→A} | b²_{B→C/C→B} | C²_{C→B/B→C} | d²_{D→C/C→D} |
| transfer of i | | | d²_{D→C/C→B} | C²_{C→D/D→C} | |
| network | competitiveness | a | a¹_{A→B} | a²_{A→B/B→C} | |
| competitiveness | increased | a²_{A→B/B→A} | | | |
| (nc²i) | amount | | | | |
| | competitiveness | b¹_{B→A} | b | b¹_{B→C} | b²_{B→C/C→D} |
| | increased | | b²_{B→A/A→B}, | | |
| | amount | | b²_{B→C/C→B} | | |
| | competitiveness | C²_{C→B/B→A} | C¹_{C→B} | C | C¹_{C→D} |
| | increased | | | C²_{C→B/B→C}, | |
| | amount | | | C²_{C→D/D→C} | |
| | competitiveness | | d²_{D→C/C→B} | d¹_{D→C} | d |
| | increased | | | | d²_{D→C/C→D} |
| | amount | | | | |
| | subtotal | a + | a¹_{A→B} + | a²_{A→B/B→C} + | b²_{B→C/C→D} + |
| | | b¹_{B→A} + | b + | b¹_{B→C} + | C¹_{C→D + d} |
| | | C²_{C→B/B→A} | C¹_{C→B} + | C + | |
| | | | d²_{D→C/C→B} | d¹_{D→C} | |

Based on the above table 3, the calculation of network competitiveness(nc²i) of node i is shown in the following mathematical equation 2.

$$[ MATHEMATICAL EQUATION 2 ]$$

$${nc}^{2} i = {nc}^{0} i + {ne}^{1} i + {ne}^{2} i = {nc}^{0} i + \sum {c}_{{nodes}^{1} \to i}^{1} + \sum {c}_{{nodes}^{2} \to i}^{2} ∴ {nc}^{2} i = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) )$$

That is, nc²i equals nc⁰i (individual competitiveness of node i) plus ne¹i (network effect by nodes') plus ne²i (network effect by nodes²)

### 4-1-4. Mutual Transfer of the 3^{rd} Competitiveness

TABLE 4

| | | node (i) | | | |
|---|---|---|---|---|---|
| | | A | B | C | D |
| individual competitiveness (nc⁰i) | | a | b | c | d |
| transfer | | b¹_{B→A} | a¹_{A→B}, C¹_{C→B} | b¹_{B→C}, d¹_{D→C} | C¹_{C→D} |
| competitiveness (i) = mutual | | | | | |
| transfer of nc⁰i | | | | | |
| transfer | | a²_{A→B/B→A} | b²_{B→A/A→B} | a²_{A→B/B→C} | b²_{B→C/C→D} |
| competitiveness (ii) = mutual | | C²_{C→B/B→A} | b²_{B→C/C→B} | C²_{C→B/B→C} | d²_{D→C/C→D} |
| transfer of i | | | d²_{D→C/C→B} | C²_{C→D/D→C} | |
| transfer | | b³_{B→A/A→B/B→A} | a³_{A→B/B→A/A→B} | b³_{B→A/A→B/B→C} | a³_{A→B/B→C/C→D} |
| competitiveness (ii) = mutual | | b³_{B→C/C→B/B→A} | a³_{A→B/B→C/C→B} | b³_{B→C/C→B/B→C} | C³_{C→B/B→C/C→D} |
| transfer of ii | | d³_{D→C/C→B/B→A} | C³_{C→B/B→A/A→B} | d³_{D→C/C→B/B→C} | C³_{C→D/D→C/C→D} |
| | | | C³_{C→B/B→C/C→B} | b³_{B→C/C→D/D→C} | |
| | | | C³_{C→D/D→C/C→B} | d³_{D→C/C→D/D→C} | |
| network | competitiveness | a | a¹_{A→B} | a²_{A→B/B→C} | a³_{A→B/B→C/C→D} |
| competitiveness | increased | a²_{A→B/B→A} | a³_{A→B/B→A/A→B} | | |
| (nc³i) | amount | | a³_{A→B/B→C/C→B} | | |
| | competitiveness | b¹_{B→A} | b | b¹_{B→C} | b²_{B→C/C→D} |
| | increased | b³_{B→A/A→B/B→A} | b²_{B→A/A→B}, | b³_{B→A/A→B/B→C} | |
| | amount | b³_{B→C/C→B/B→A} | b²_{B→C/C→B} | b³_{B→C/C→B/B→C} | |
| | | | | d³_{D→C/C→B/B→C} | |
| | | | | b³_{B→C/C→D/D→C} | |
| | competitiveness | C²_{C→B/B→A} | C¹_{C→B} | C | C¹_{C→D} |
| | increased | | C³_{C→B/B→A/A→B} | C²_{C→B/B→C} | C³_{C→B/B→C/C→D} |
| | amount | | C³_{C→B/B→C/C→B} | C²_{C→D/D→C} | C³_{C→D/D→C/C→D} |
| | | | C³_{C→D/D→C/C→B} | | |
| | competitiveness | d³_{D→C/C→B/B→A} | d²_{D→C/C→B} | d¹_{D→C} | d |
| | increased | | | d³_{D→C/C→D/D→C} | d²_{D→C/C→D} |
| | amount | | | | |
| | subtotal | a + | a¹_{A→B} + | a²_{A→B/B→C} + | a³_{A→B/B→C/C→D} + |
| | | b¹_{B→A} + | b + | b¹_{B→C} + | b²_{B→C/C→D} + |
| | | C²_{C→B/B→A} + | C¹_{C→B} + | C + | C¹_{C→D} + d |
| | | d³_{D→C/C→B/B→A} | d²_{D→C/C→B} | d¹_{D→C} | |

Based on the above table 4, the calculation of network competitiveness(nc³i) of node i is shown in the following mathematical equation 3.

$$[ MATHEMATICAL EQUATION 3 ]$$

$${nc}^{3} i = {nc}^{0} i + {ne}^{1} i + {ne}^{2} i + {ne}^{3} i = {nc}^{0} i + \sum {c}_{{nodes}^{1} \to i}^{1} + \sum {c}_{{nodes}^{2} \to i}^{2} + \sum {c}_{{nodes}^{3} \to i}^{3} ∴ {nc}^{3} i = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times {nc}^{0} {nodes}^{3} ) ) )$$

That is, nc³i equals nc⁰i(individual competitiveness of node i) plus ne¹i (network effect by nodes¹) plus ne²i (network effect by nodes²) plus ne³i (network effect by nodes³)

### 4-1-5. Equation for Measuring Network Competitiveness of Each Node

The equation for measuring network competitiveness of node i may be defined as the following mathematical equation 4 by using mathematical equations 1˜3.

$$[ MATHEMATICAL EQUATION 4 ]$$

$${nc}^{n} i = {nc}^{0} i + {ne}^{1} i + {ne}^{2} i + {ne}^{3} i + … + {ne}^{n} i = {nc}^{0} i + \sum {c}_{{nodes}^{1} \to i}^{1} + \sum {c}_{{nodes}^{2} \to i}^{2} + \sum {c}_{{nodes}^{3} \to i}^{3} + … + \sum {c}_{{nodes}^{n} \to i}^{n} ∴ {nc}^{n} i = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times {nc}^{0} {nodes}^{3} ) ) ) + … + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times … \times \sum ( {SI}_{{nodes}^{n - 1} \to {nodes}^{n - 2}} ( \% ) \times {α}_{{nodes}^{n - 1} \to {nodes}^{n - 2}} ( \% ) \times \sum ( {SI}_{{nodes}^{n} \to {nodes}^{n - 1}} ( \% ) \times {α}_{{nodes}^{n} \to {nodes}^{n - 1}} ( \% ) \times {nc}^{0} {nodes}^{n} ) … )$$

### 4-1-6. Amendment of Equation for Measuring Network Competitiveness

In case of calculating network competitiveness of node A by ^{Π}4-1-5. Equation for measuring network competitiveness of each nodes_{┘}, mentioned above, in the social network shown in FIG. 8, the network effect by node C is calculated to be all included in the 1^{st}, 2^{nd}, 3^{rd} network effect. Also, the network effect by node D is increased by double calculation as a path connecting to nodes B and C upon calculating the 2^{nd} network effect and therefore, it is necessary to generalize the method of amending the above.

\textcircled{1} Condition for Each Node

TABLE 5

| node(/) | A | B | C | D |
|---|---|---|---|---|
| individual | a | b | c | d |
| competitiveness (nc⁰/) | | | | |
| competitiveness | α_{A→B} | α_{B→A} | α_{C→A} | α_{D→B} |
| transfer potential factor | α_{A→C} | α_{B→C} | α_{C→B} | α_{D→C} |
| among nodes (potential | | α_{B→D} | α_{C→D} | |
| factor) | | | | |
| social index(SI) among | SI_{A-B} | SI_{B-A} | SI_{C-A} | SI_{D-B} |
| nodes | SI_{A-C} | SI_{B-C} | SI_{C-B} | SI_{D-C} |
| | | SI_{B-D} | SI_{C-D} | |
| potential transfer | Ca = α_{A}(%) × | Cb = α_{B}(%) × | Cc = α_{C}(%) × | Cd = α_{D}(%) × |
| competitiveness | a | b | c | d |
| transfer | ca | cb | cc | cd |
| competitiveness (mutual | — | =SI_{B-A}(%) × | =SI_{C-A}(%) × | =SI_{D-C}(%) × |
| transfer with the 1^{st} ties | | α_{B→A}(%) × b | α_{C→A}(%) × c | α_{D→C}(%) × d |
| network, strong ties, c/) | | =b¹_{B→A} | =c¹_{C→A} | =d¹_{D→C} |
| | =SI_{A-B}(%) × | =SI_{B-C}(%) × | =SI_{C-B}(%) × | =SI_{D-B}(%) × |
| | α_{A→B}(%) × a | α_{B→C}(%) × b | α_{C→B}(%) × c | α_{D→B}(%) × d |
| | =a¹_{A→B} | =b¹_{B→C} | =c¹_{C→B} | =d¹_{D→B} |
| | =SI_{A-C}(%) × | =SI_{B-D}(%) × | =SI_{C-D}(%) × | |
| | α_{A→C}(%) × a | α_{B→D}(%) × b | α_{C→D}(%) × c | |
| | =a¹_{A→C} | =b¹_{B→D} | =c¹_{C→D} | |
| | — | | | |

x¹_{1,}: A superscript and a subscript mean the frequency of
transfer and transfer direction for sequence, respectively.

\textcircled{2} Calculation of Network Effect and Network Competitiveness for Each Node

TABLE 6

| node(i) | | A | B | C | D |
|---|---|---|---|---|---|
| individual | | a | b | c | d |
| competitiveness | | | | | |
| (nc⁰i) | | | | | |
| 1st | formula | ne¹i = Σ(SI_{nodes}_{¹}_{→i}(%) × α_{nodes}_{¹}_{→i}(%) × nc⁰nodes¹) | | | |
| ties | ne¹i | b¹_{B→A},c¹_{C→A} | a¹_{A→B},c¹_{C→B}, | a¹_{A→C}, b¹_{B→C}, | b¹_{B→D}, c¹_{C→D} |
| | | | d¹_{D→B} | d¹_{D→C} | |
| | nc¹i = | a + | a¹_{A→B} + | a¹_{A→C} + | b¹_{B→D} + |
| | nc⁰i + | b¹_{B→A} + | b + | b¹_{B→C} + | c¹_{C→D} + |
| | ne¹i | c¹_{C→A} | c¹_{C→B} + | c + | d |
| | | | d¹_{D→B} | d¹_{D→C} | |
| | | increase | Increased amount is excepted from object of | | |
| | | | calculating network competitiveness, but no | | |
| | | | increased amount in first calculation. | | |
| 2nd | formula | ne²i = Σ(SI_{nodes}_{¹}_{→i}(%) × α_{nodes}_{¹} _{→i}(%) × Σ(SI_{nodes}_{²}_{→nodes}_{¹}(%) × | | | |
| ties | | α_{nodes}_{²}_{→nodes}_{¹}(%) × nc⁰nodes²)) | | | |
| | ne²i | b²_{B→C/C→A} | a²_{A→C/C→B} | a²_{A→B/B→C} | a²_{A→B/B→D} |
| | | c²_{C→B/B→A} | c²_{C→A/A→B} | b²_{B→A/A→C} | 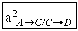 |
| | | d²_{D→C/C→A} | 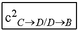 | 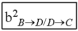 | b²_{B→C/C→D} |
| | | 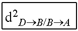 | d²_{D→C/C→B} | d²_{D→B/B→C} | c²_{C→B/B→D} |
| | | increase | Increased amount is excepted from object of | | |
| | | | calculating network competitiveness. | | |
| | | | Same node is increased from the next degree | | |
| | | | calculation to path expansion.: italic | | |
| | | | Same node is increased from the same degree | | |
| | | | calculation to dual path.: The underlined | | |
| | nc²i = | a + | a¹_{A→B} + | a¹_{A→C} + | a²_{A→B/B→D} + |
| | nc⁰i + | b¹_{B→A} + | b + | b¹_{B→C} + | b¹_{B→D} + |
| | ne¹i + | c¹_{C→A} + | c¹_{C→B} + | c + | c¹_{C→D} + |
| | ne²i | d²_{D→C/C→A} | d¹_{D→B} | d¹_{D→C} | d |
| 3rd | formula | ne³i = Σ(SI_{nodes}_{¹}_{→i}(%) × α_{nodes}_{¹}_{→i}(%) × Σ(SI_{nodes}_{²}_{→nodes}_{¹}(%) × | | | |
| ties | | α_{nodes}_{²}_{→nodes}_{¹}(%) × Σ(SI_{nodes}_{³}_{→nodes}_{²}(%) × α_{nodes}_{³}_{→nodes}_{²}(%) × | | | |
| | | nc⁰nodes³))) | | | |
| | ne³i | b³_{B→D/D→C/C→A} | a³_{A→C/C→D/D→B} | a³_{A→B/B→D/D→C} | a³_{A→C/C→B/B→D} |
| | | c³_{C→D/D→B/B→A} | d³_{D→C/C→A/A→B} | d³_{D→B/B→A/A→C} | 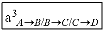 |
| | | d³_{D→C/C→B/B→A} | | | b³_{B→A/A→C/C→D} |
| | | 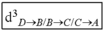 | | | c³_{C→A/A→B/B→D} |
| | | increase | Increased amount is excepted from object of | | |
| | | | calculating network competitiveness. | | |
| | | | Same node is increased from the next degree | | |
| | | | calculation to path expansion.: italic | | |
| | | | Same node is increased from the same degree | | |
| | | | calculation to dual path.: The underlined | | |
| | nc³i = | a + | a¹_{A→B} + | a¹_{A→C} + | a²_{A→B/B→D} + |
| | nc⁰i + | b¹_{B→A} + | b + | b¹_{B→C} + | b¹_{B→D} + |
| | ne¹i + | c¹_{C→A} + | c¹_{C→A} + | c + | c¹_{C→D} + |
| | ne²i + | d²_{D→C/C→A} | d¹_{D→B} | d¹_{D→C} | d |
| | ne³i | | | | |

\hat{3} Increase by Calculation of Network Competitiveness

In case of calculation based on ^{┌}4-1-5. Equation for measuring network competitiveness of each node_{┘}, mentioned above, i) the same node expands its path in the next degree calculation, and ii) the same node is calculated and increased to various paths in the same degree calculation.

\textcircled{4} The Method for Amending Increase Effects by Calculation of Network Effect and Network Competitiveness of Each Node

As the equation for measuring network competitiveness of each node, the increase effects of calculating network effect and network competitiveness of each node is amended by following processes.

Upon calculating network effect and competitiveness, if competitiveness of the same node is transferred and increased by expanding a path in the next degree calculation, one of three methods, as below, is selected.

\textcircled{a} The network effect having the lowest degree in a network is applied(In this case, nodes already calculated in degree, below n^{th}, upon calculating n^{th} network effect are not included).
\textcircled{b} The biggest network effect among all network effects is applied.

\textcircled{c} The average of all network effects is used.

Further, upon calculating network effect and competitiveness, ii) the biggest network effect among all network effects is applied when competitiveness of the same node is transferred and increased through various paths in the same degree calculation.

FIG. 9 is a flow chart illustrating the calculating process to which the largest network effect is applied upon calculating network effect and competitiveness according to the present invention.

FIG. 10 is a flow chart illustrating the calculating process in which the average of network effect is used upon calculating network effect and competitiveness according to the present invention.

5. Measuring Network Competitiveness in Social Network

### 5-1. Competitiveness of Node and Tie and Competitivenes Transfer Elements in a Network

Individual competitiveness of each node and tie and competitiveness transfer elements which are required for calculation of network competitiveness of each node are shown in the table 7 and FIG. 11.

TABLE 7

| node | A, B, C, D, E, F |
|---|---|
| social capital evaluation | SEIi(SEI_{A→B}, SEI_{B→A}, SEI_{A→C}, SEI_{C→A}, SEI_{A→D}, |
| index(SEI) between each node | SEI_{D→A}, SEI_{A→E}, SEI_{E→A}, SEI_{E→F}, SEI_{F→E}) |
| social capital index(SCI) | SCIi(SCI_{A-B} = SCI_{B-A}, SCI_{A-C} = SCI_{C-A}, SCI_{A-D} = |
| between each node | SCI_{D-A}, SCI_{A-E} = SCI_{E-A}, SCI_{E-F} = SCI_{F-E}) |
| socio-capitalization of each | capi(cap a, cap b, cap c, cap d, cap e, cap f) |
| node | |
| total competitiveness each node | tot Ci(tot Ca, tot Cb, tot Cc, tot Cd, tot Ce, tot |
| owns | Cf) |
| competitiveness transfer | αi(α_{A→B}, α_{B→A}, α_{A→C}, α_{C→A}, α_{A→D}, α_{D→A}, α_{A→E}, |
| potential factor of each node | α_{E→A}, α_{E→F}, α_{F→E}) |
| transfer potential | Ci(Ca, Cb, Cc, Cd, Ce, Cf) = αi × (tot Ci or |
| competitiveness of each node | capi) |
| transfer competitiveness of each | ci(ca, cb, cc, cd, ce, cf) = SCIi × Cior SEIi × |
| node | Ci |
| network competitiveness of each | nci(nca, ncb, ncc, ncd, nce, ncf) |
| node | |

### 5-2. Calculating Social Index and Competitiveness Transfer Potential Factor Among Each Node

The method for measuring social index and competitiveness transfer potential factor among each node connected in an online social network is as follows, and this is shown in Korean Patent No. 10-0933995 (System and method for measuring social capital index in an online social network) filed by the present applicant.

### 5-2-1. Factor and Method for Measuring Social Capital

When nodes are connected in an online social network, that is, a human network is established, social capital among nodes may be measured by estimating others based on following evaluation factors and standards.

Specific factors and methods are the same as below. Evaluation factors, weight and standards for evaluation (1˜5) may be changed and applied depending on the purpose of calculation.

\textcircled{1} Evaluation Factors and Weights for Social Capital Index

TABLE 8

| | | EVALUATED | |
|---|---|---|---|
| ITEM | CONSTITUTION | DESCRIPTIONS | WEIGHT |
| Social capital index | — | — | 100% |
| \textcircled{1}trust index(TI) | trust | will and ability for | 30% |
| | | keeping a promise | |
| \textcircled{2}integrity | integrity | will and ability for | 30% |
| index(II) | | keeping a promise | |
| \textcircled{3}solidarity | solidarity | will and ability for | 15% |
| index(SI) | | unity | |
| \textcircled{4}openness | openness | will and ability for | 15% |
| index(OI) | | open | |
| \textcircled{5}Importance | importance | will and ability for | 5% |
| index(IMI) | | importance | |
| \textcircled{6}intimacy | intimacy | will and ability for | 5% |
| index(INI) | | intimacy | |

\textcircled{2} Social Capital Evaluation Table (Provided to the Front of Both Evaluators)

TABLE 9

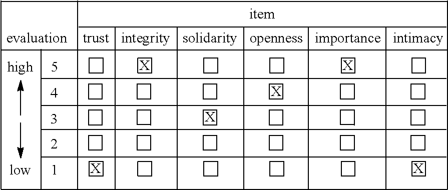

\textcircled{4} Indexing Table

TABLE 10

| | classification | | | |
|---|---|---|---|---|
| | Evaluation | | | individual index = |
| item | A [symbol] B | B [symbol] A | total | total × 10 |
| trust | 5 | 5 | 10 | 100 |
| integrity | 5 | 4 | 9 | 90 |
| solidarity | 4 | 5 | 9 | |
| openness | 5 | 3 | 8 | 80 |
| importance | 4 | 4 | 8 | |
| intimacy | 3 | 5 | 8 | |
| | 5 | 2 | 7 | 70 |
| | 4 | 3 | 7 | |
| | 3 | 4 | 7 | |
| | 2 | 5 | 7 | |
| | 5 | 1 | 6 | 60 |
| | 4 | 2 | 6 | |
| | 3 | 3 | 6 | |
| | 2 | 4 | 6 | |
| | 1 | 5 | 6 | |
| | 4 | 1 | 5 | |
| | 3 | 2 | 5 | 50 |
| | 2 | 3 | 5 | |
| | 1 | 4 | 5 | |
| | 3 | 1 | 4 | 40 |
| | 2 | 2 | 4 | |
| | 1 | 3 | 4 | |
| | 2 | 1 | 3 | 30 |
| | 1 | 2 | 3 | |
| | 1 | 1 | 2 | 20 |

### 5-2-2. Calculation of Social Capital Index

If connected nodes A and B are mutually evaluated based on ^{┌}5-2-1. Factor and method for measuring social capital_{┘}, mentioned above, as follows, social capital index(SCI_{A-B}=SCI_{B-A}) is the same as below and the lowest and highest indexes are computed as 20 and 100, respectively.

Specific factors and methods are shown in Tables 11 and 12. Evaluation factors, weight and standards for evaluation (1-5) may be changed and applied depending on the purpose of calculation.

TABLE 11

| | | | | calculation | | |
|---|---|---|---|---|---|---|
| | | | | | social capital | |
| evaluation | | evaluation | | individual | index | |
| factor | weight | A [symbol] B | B [symbol] A | index | SCI_{A-B} = SCI_{B-A} | |
| trust | 30% | 5 | 1 | 60 | 30% × 60 | 18.0 |
| integrity | 30% | 4 | 2 | 60 | 30% × 60 | 18.0 |
| solidarity | 15% | 2 | 3 | 50 | 15% × 50 | 7.5 |
| openness | 15% | 1 | 5 | 60 | 15% × 60 | 9.0 |
| importance | 5% | 3 | 3 | 60 | 5% × 60 | 3.0 |
| intimacy | 5% | 2 | 4 | 60 | 5% × 60 | 3.0 |
| Social | 100% | — | — | — | — | 58.5 |
| capital | | | | | | |
| index | | | | | | |

TABLE 12

| item | index |
|---|---|
| Social capital index(SCI) | 58.5 |
| trust index(TI) | 60.0 |
| integrity index(II) | 60.0 |
| solidarity index(SI) | 50.0 |
| openness index(OI) | 60.0 |
| Importance index(IMI) | 60.0 |
| intimacy index(INI) | 60.0 |

If the lowest grade is automatically given in non-evaluation after establishing a human network, it is the same as Tables 13 and 14.

TABLE 13

| | | | | measurement | | |
|---|---|---|---|---|---|---|
| evaluation | | evaluation | | individual | social capital | |
| factor | weight | A [symbol] B | B [symbol] A | index | index | |
| trust | 30% | 1 | 1 | 20 | 30% × 20 | 6.0 |
| integrity | 30% | 1 | 1 | 20 | 30% × 20 | 6.0 |
| solidarity | 15% | 1 | 1 | 20 | 15% × 20 | 3.0 |
| openness | 15% | 1 | 1 | 20 | 15% × 20 | 3.0 |
| importance | 5% | 1 | 1 | 20 | 5% × 20 | 1.0 |
| intimacy | 5% | 1 | 1 | 20 | 5% × 20 | 1.0 |
| Social | 100% | — | — | — | — | 20.0 |
| capital | | | | | | |
| index | | | | | | |

TABLE 14

| item | index |
|---|---|
| Social capital index(SCI) | 20.0 |
| trust index(TI) | 20.0 |
| integrity index(II) | 20.0 |
| solidarity index(SI) | 20.0 |
| openness index(OI) | 20.0 |
| Importance index(IMI) | 20.0 |
| intimacy index(INI) | 20.0 |

Also, the social capital index among each node is calculated by measuring social capital among each node A, B, C, D, E and F (SCI_{A-B} of FIG. 11=SCI_{B-A}, SCI_{A-C}==SCI_{C-A}, SCI_{A-D}=SCI_{D-A}, SCI_{A-E}=SCI_{E-F}=SCI_{F-E}).

### 5-2-3. Calculating Social Capital Evaluation Index

If connected nodes A and B are mutually evaluated based on ^{┌}5-2-1. Factor and method for measuring social capital_{┘}, mentioned above, as follows, social capital index is the same as Table 15 and the lowest and highest indexes are computed as 20 and 100, respectively.

Specific factors and methods are the same as below. Evaluation factors, weight and standards for evaluation (1˜5) may be changed and applied depending on the purpose of calculation.

TABLE 15

| | | index | | | | | |
|---|---|---|---|---|---|---|---|
| | | SEI_{A→B} | | | SEI_{B→A} | | |
| | | A's | | | B's | | |
| classification | | evaluation | amendment | computation | evaluation | amendment | computation |
| trust | 30% | 5 | ×20 | 30.0 | 1 | ×20 | 6.0 |
| integrity | 30% | 4 | | 24.0 | 2 | | 12.0 |
| solidarity | 15% | 2 | | 6.0 | 3 | | 9.0 |
| openness | 15% | 1 | | 3.0 | 5 | | 15.0 |
| importance | 5% | 3 | | 3.0 | 3 | | 3.0 |
| intimacy | 5% | 2 | | 2.0 | 4 | | 4.0 |

| | | | | |
|---|---|---|---|---|
| total | — | 68.0 | — | 49.0 |

Also, the bi-directional social capital index among each node is calculated by using mutually asymmetric standards for evaluation for measuring social capital among each node A, B, C, D, E and F (SEI_{A-B} of FIG. 11, SEI_{B-A}, SEI_{A-C}, SEI_{A-D}, SEI_{D-A}, SEI_{A-E}, SEI_{E-A}, SEI_{E-F}, SEI_{F-E}).

### 5-2-4. Calculating Competitiveness Transfer Potential Factor(α)

Competitiveness of each node is mutually transferred with the 1^{st} ties related nodes¹ via ties, which are connection paths among nodes. Also, the competitiveness transfer potential factor(α) is computed as below, considering that the whole competitiveness is actually not transferred due to various reasons like intimacy among nodes, imbalance of Needs information, a lack of time and interests, etc. and the only partial competitiveness may be transferred.

If connected nodes A and B are mutually evaluated based on ^{Π}5-2-1. Factor and method for measuring social capital_{┘}, mentioned above, as follows, the competitiveness transfer potential factor is the same as Table 16 and the lowest and highest indexes are computed as 2 and 10, respectively.

Specific factors and methods are the same as below. Evaluation factors, weight and standards for evaluation (1˜5) may be changed and applied depending on the purpose of calculation.

TABLE 16

| | | item | | | |
|---|---|---|---|---|---|
| | | α_{A→B} | | α_{B→A} | |
| | | A's | | B's | |
| classification | | evaluation | computation | evaluation | computation |
| importance | 100% | 5 | 5.0 | 1 | 1.0 |
| intimacy | 100% | 5 | 5.0 | 1 | 1.0 |

| | | | | |
|---|---|---|---|---|
| total | — | 10.0 | — | 2.0 |

Also, the bi-directional competitiveness transfer potential factor among each node is calculated by using mutually asymmetric standards for evaluation for measuring competitiveness transfer potential factor among each node A, B, C, D, E and F (α_{A→B} of FIG. 11, α_{B→A}, α_{A→C}, α_{C→A}, α_{A→D}, α_{D→A}, α_{A→E}, α_{E→A}, α_{E→F}, α_{F→E}).

### 5-3. Measuring Network Competitiveness of Each Node

### 5-3-1. Individual Competitiveness of Each Node

### 5-3-1-1. Socio-Capitalization (CAP i) of Each Node

The social capital index among each node is calculated based on ^{Π}5-2-2. Calculating social capital index_{┘}, mentioned above, and the socio-capitalization is calculated by adding social capital index with all 1^{st} ties related nodes¹ toward each node A, B, C, D, E and F (CAP A, CAP B, CAP C, CAP D, CAP E and CAP F of FIG. 11). At this time, the socio-capitalization means the total amount of “space competitiveness” that all nodes¹ related to individuals and 1^{st} ties have.

There is no socio-capitalization value in non-connected independent nodes. Therefore, the network competitiveness is computed as “0”, applying the value of individual competitiveness to socio-capitalization.

### 5-3-1-2. Total Competitiveness (Tot Ci) of Each Node

Various competitiveness factors such as globalization index, social broker index, celebrity index of each node are separately measured.

Total competitiveness of individuals is calculated by applying appropriate weights to individual's various competitiveness factors such as socio-capitalization, globalization index, social broker index, celebrity index of each node (tot Ca, tot Cb, tot Cc, tot Cd, tot Ce, and tot Cf).

### 5-3-1-3. Applying Individual Competitiveness

Individual competitiveness which is applied to ^{Π}5-7. Formula for measuring network effect and network competitiveness in social network_{┘}, mentioned above, is classified into ^{Π}5-3-1-1. Socio-capitalization (CAP i) of each node_{┘} and ^{Π}5-3-1-2. Total competitiveness of each node_{┘}, mentioned above. Individual competitiveness is properly selected in accordance with the purpose of calculation.

### 5-4. Formula Regarding Transfer Potential Competitiveness

Transfer potential competitiveness of each node considering competitiveness transfer potential factor(α) is defined as follows (Refer to FIG. 11).

According to ^{Π}5-2-4. Calculating competitiveness transfer potential factor_{┘}, mentioned above, the competitiveness transfer potential factor(α) is evaluated in the range of 2 to 10. It is applied to the below mathematical equation 5, wherein the highest value, 10, is converted(2%˜10%) on a basis of 10%.

transfer potential competitiveness from node i to nodes¹=competitiveness transfer potential factor from node i to nodes¹(%)×individual competitiveness that node i owns

∴transfer potential competitiveness Ci=α_{i→nodes}¹(%)×(tot Ci or capi) [MATHEMATICAL EQUATION 5]

### 5-5. Formula Regarding Transfer Competitiveness of Each Node

Mutual transfer of competitiveness among each node in a network is performed by ties, which are connection paths among each node, wherein competitiveness transfer is limited depending to features of ties.

There are two kinds of social index and competitiveness transfer potential index in ties among nodes, wherein a symmetrical factor in the process of measuring social capital corresponds to \textcircled{1} social capital index, and asymmetric factors correspond to \textcircled{2} social capital evaluation index and \textcircled{3} competitiveness transfer potential factor(a) (Refer to FIG. 12).

Transfer competitiveness, transferred along with ties, is affected by \textcircled{1} social capital index and \textcircled{2} social capital evaluation index, which function with an appropriate rate as information on ties upon calculating transfer competitiveness of each node and thus, transfer competitiveness of each node is defined as two types as follows.

### 5-5-1. Formula Regarding Transfer Competitiveness Applied to Social Capital Index

Mutual transfer of competitiveness among each node is performed by ties, which are connection paths among each node, and each amount of bi-directional transfer is limited based on the level of social capital index which can be seen by cross section of ties, which are connection paths of nodes. Therefore, transfer competitiveness of each node is defined as follows.

According to ^{Π}5-2-2. Calculating social capital index_{┘}, mentioned above, the social capital index is evaluated in the range of 20 to 100. It is applied to the below mathematical equation 6, wherein the highest value, 100, is converted(20%˜100%) on a basis of 100% according to the purpose of calculation.

If the social capital index is applied to mathematical equation 6, the constant rate is applied among nodes.

transfer competitiveness from node i to nodes¹=social capital index from node i to nodes¹(%)×transfer potential competitiveness from node i to nodes¹ [MATHEMATICAL EQUATION 6]

∴ci=SCI_{i-nodes}¹(%)×Ci=SCI_{i-nodes}¹(%)×α_{i→nodes}¹(%)×(tot Ci or cap i), ci≦Ci

### 5-5-2. Formula Regarding Transfer Competitiveness Applied to Social Capital Evaluation Index

Mutual transfer of competitiveness among each node is performed by ties, which are connection paths among each node, and each amount of bi-directional transfer is limited based on the level of asymmetric social capital index among nodes. Therefore, transfer competitiveness of each node is defined as follows.

According to ^{Π}5-2-3. Calculating social capital evaluation index_{┘}, mentioned above, the social capital evaluation index is evaluated in the range of 20 to 100. It is applied to the below mathematical equation 7, wherein the highest value, 100, is converted(20%˜100%) on a basis of 100% according to the purpose of calculation.

If the social capital evaluation index is applied to mathematical equation 7, asymmetric rates are applied among nodes, respectively.

transfer competitiveness from node i to nodes¹=social capital evaluation index from node i to nodes¹(%)×transfer potential competitiveness from node i to nodes¹ [MATHEMATICAL EQUATION 7]

∴ci=SEI_{i-nodes}¹(%)×Ci=SEI_{i→nodes}¹(%)×α_{i→nodes}¹(%)×(tot Ci or cap i), ci≦Ci

### 5-6. Network Effect

According to ^{Π}Derivation of formula for measuring network effect and network competitiveness in social network_{┘}, mentioned above, the network effect by nodes¹, nodes², nodes³, nodes⁴ to nodesⁿ with arbitrary nodes may be defined as seen in mathematical equation 8. This is an indicator showing how much the network that belongs to each node affects each node.

$$[ MATHEMATICAL EQUATION 8 ]$$

$$Each network effect by {nodes}^{1} ∼ {nodes}^{n} of nodes i is as follows \text{:}$$

$${ne}^{1} i = \sum ( {SI}_{{nodes}^{1} \to i} ( \% ) \times {α}_{{nodes}^{1} \to i} ( \% ) \times {nc}^{0} {nodes}^{1} )$$

$${ne}^{2} i = \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) )$$

$${ne}^{3} i = \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times {nc}^{0} {nodes}^{3} ) ) ) …$$

$${ne}^{n} i = \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times … \times \sum ( {SI}_{{nodes}^{n - 1} \to {nodes}^{n - 2}} ( \% ) \times {α}_{{nodes}^{n - 1} \to {nodes}^{n - 2}} ( \% ) \times \sum ( {SI}_{{nodes}^{n} \to {nodes}^{n - 1}} ( \% ) \times {α}_{{nodes}^{n} \to {nodes}^{n - 1}} ( \% ) \times {nc}^{0} {nodes}^{n} ) … )$$

Upon calculating network effect by mathematical equation 8,

i) if competitiveness of the same node is transferred and increased by expanding a path in the next degree calculation, one of three methods, as below, is selected.

\textcircled{1} The network effect having the lowest degree in a network is applied(In this case, nodes already calculated in degree, below n^{th}, upon calculating n^{th} network effect are not included).

\textcircled{2} The biggest network effect among all network effects is applied.

\textcircled{3} The average of all network effects is used.

ii) The biggest network effect among all network effects is applied when competitiveness of the same node is transferred and increased through various paths in the same degree calculation. Also, upon calculating network effect of each node, it is amended as illustrated in FIGS. 9 and 10.

Furthermore, total network effect, of node i equals ncⁿi (total network competitiveness of node i) minus nc⁰i (individual competitiveness of node i).

### 5-7. Formula for Measuring Network Effect and Network Competitiveness in Social Network

The formula regarding network competitiveness(ncⁿi) to summarize from nodes¹ of node i to nodesⁿ is the same as the below mathematical equation 9, and it is calculated once up to nodesⁿ toward all nodes.

$$[ MATHEMATICAL EQUATION 9 ]$$

$${nc}^{n} i = {nc}^{0} i + {ne}^{1} i + {ne}^{2} i + {ne}^{3} i + … + {ne}^{n} i = {nc}^{0} i + \sum {c}_{{nodes}^{1} \to i}^{1} + \sum {c}_{{nodes}^{2} \to i}^{2} + \sum {c}_{{nodes}^{3} \to i}^{3} + … + \sum {c}_{{nodes}^{n} \to i}^{n} = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times {nc}^{0} {nodes}^{3} ) ) ) + … + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times … \times \sum ( {SI}_{{nodes}^{n - 1} \to {nodes}^{n - 2}} ( \% ) \times {α}_{{nodes}^{n - 1} \to {nodes}^{n - 2}} ( \% ) \times \sum ( {SI}_{{nodes}^{n} \to {nodes}^{n - 1}} ( \% ) \times {α}_{{nodes}^{n} \to {nodes}^{n - 1}} ( \% ) \times {nc}^{0} {nodes}^{n} ) … )$$

At this time, terms of the mathematical equation 9 are listed in the below table 17.

TABLE 17

| | |
|---|---|
| nc⁰i | individual competitiveness obtained by node i, |
| | classified into \textcircled{1}social capitalization and \textcircled{2}total |
| | competitiveness and selected according to the purpose |
| | of calculation |
| ncⁿi | network competitiveness by nodes¹ ~ nodesⁿ of node i |
| nodesⁿ | n^{th} ties network of node i in social network |
| nc⁰nodesⁿ | individual competitiveness obtained by nodesⁿ of |
| | node i |
| α | competitiveness transfer potential factor of node i |
| α_{nodes}ⁿ_{→nodes}ⁿ⁻¹ | competitiveness transfer potential factor to the |
| | direction of nodesⁿ⁻¹ among competitiveness |
| | transfer potential factor obtained by nodesⁿ of node i |
| SI | social index obtained by node i, classified into \textcircled{1} |
| | social capital index and \textcircled{2}social capital evaluation |
| | index and selected according to the purpose |
| | of calculation |
| SI_{nodes}ⁿ_{→nodes}ⁿ⁻¹ | social index connected to the direction of nodesⁿ⁻¹ |
| | among social indexes obtained by nodesⁿ of node i |
| neⁿi | network effect by nodesⁿ of node i |
| Cⁿ_{nodes}ⁿ_{→i} | transfer competitiveness from nodesⁿ of node i to |
| | nodes i |

Upon calculating network competitiveness by mathematical equation 9,

i) if competitiveness of the same node is transferred and increased by expanding a path in the next degree calculation, one of three methods, as below, is selected.

\textcircled{1} The network effect having the lowest degree in a network is applied(In this case, nodes already calculated in degree, below n^{th}, upon calculating n^{th} network effect are not included).

\textcircled{2} The biggest network effect among all network effects is applied.

\textcircled{3} The average of all network effects is used.

ii) The biggest network effect among all network effects is applied when competitiveness of the same node is transferred and increased through various paths in the same degree calculation. Also, upon calculating network competitiveness of each node, it is amended as illustrated in FIGS. 9 and 10.

### 5-8. Calculation Method for Measuring Network Effect and Network Competitiveness in Social Network

^{┌}5-7. Formula for measuring network effect and network competitiveness in social network_{┘}, mentioned above, refers to a formula for calculating network effect and network competitiveness from nodes¹ to nodesⁿ of node i, wherein the competitiveness of nodes¹ (1^{st} ties network) is transferred to node i when “n” equals 1 and the competitiveness of nodes¹ and nodes² is transferred to node i when “n” equals 2. Therefore, in case of n^{th} calculation, the network effect and network competitiveness are calculated by transferring the competitiveness in the range of nodes¹ to nodesⁿ to node i.

The formula regarding network competitiveness(ncⁿi) from nodes¹ to nodesⁿ of node i in a social network is calculated once up to nodesⁿ toward all nodes.

There are two kinds of \textcircled{1} socio-capitalization and \textcircled{2} total competitiveness in individual competitiveness(ncⁿi) in all nodes, and it is selected depending on the purpose of calculation.

Except independent nodes, there is information on competitiveness transfer potential factor and social index in ties of all connected nodes.

According to ^{Π}5-2-4. Calculating competitiveness transfer potential factor_{┘}, mentioned above, the competitiveness transfer potential factor(α) of all nodes except independent nodes is evaluated in the range of 2 to 10. It is applied to formulas, wherein the highest value, 10, is converted(2% 10%) on a basis of 10% according to the purpose of calculation.

Social index of all nodes except independent nodes indicates social index, information on ties among each node; and there are two kinds of social capital index for measuring social capital and social capital evaluation index in social index. One of them is applied and used in accordance with the purpose of calculation.

According to ^{Π}5-2-2. Calculating social capital index_{┘}, mentioned above, the social capital index of all nodes except independent nodes is evaluated in the range of 20 to 100. It is applied to formulas, wherein the highest value, 100, is converted(20%˜100%) on a basis of 100% according to the purpose of calculation.

According to ^{Π}5-2-3. Calculating social capital evaluation index_{┘}, mentioned above, the social capital evaluation index of all nodes except independent nodes is evaluated in the range of 20 to 100. It is applied to formulas, wherein the highest value, 100, is converted(20%˜100%) on a basis of 100% according to the purpose of calculation.

Since competitiveness transfer potential factor and social index of all nodes except independent nodes keep changed in accordance with real-time mutual evaluation of members, the competitiveness transfer potential factor, social capital index and social capital evaluation index in a calculation process are continuously applied to a fixed value, available to previous new evaluation, until the end of calculation.

Meanwhile, since social interchange of people is generated only up to the level of a human network of their human network, i.e., nodes² (the 2^{nd} ties network, human network of human network), nodes¹ and nodes² competitiveness commonly affect some particular people.

Therefore, the calculation of network competitiveness of all nodes by ^{Π}5-7. Formula for measuring network effect and network competitiveness in social network_{┘}, mentioned above, is generally calculated once up to nodes²(n=2) or nodes³(n=3) toward all nodes of a network as seen in the below mathematical equation 10, and the degree is decreased in accordance with the purpose of calculation (Refer to FIG. 13).

$$[ MATHEMATICAL EQUATION 10 ]$$

$${nc}^{3} i = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) ) + \sum ( {SI}_{{nodes}^{1} \to i} ( \% ) \times {α}_{{nodes}^{1} \to i} ( \% ) \times \sum ( {SI}_{{nodes}^{2} \to {nodes}^{1}} ( \% ) \times {α}_{{nodes}^{2} \to {nodes}^{1}} ( \% ) \times \sum ( {SI}_{{nodes}^{3} \to {nodes}^{2}} ( \% ) \times {α}_{{nodes}^{3} \to {nodes}^{2}} ( \% ) \times {nc}^{0} {nodes}^{3} ) ) )$$

Upon calculating network effect and competitiveness by mathematical equations 8 and 9,

i) if competitiveness of the same node is transferred and increased by expanding a path in the next degree calculation, one of three methods, as below, is selected.

\textcircled{1} The network effect having the lowest degree in a network is applied(In this case, nodes already calculated in degree, below n^{th}, upon calculating n^{th} network effect are not included).

\textcircled{2} The biggest network effect among all network effects is applied.

\textcircled{3} The average of all network effects is used.

ii) The biggest network effect among all network effects is applied when competitiveness of the same, node is transferred and increased through various paths in the same degree calculation. Also, upon calculating network competitiveness of each node, it is amended as illustrated in FIGS. 9 and 10.

In addition, a network is constituted with a main network and a minor network(a small-sized network including independent nodes no joined to a main network), and upon calculating network competitiveness of nodes included to each network, if n−1th calculation results is the same as nth calculation results, the result value is considered as network competitiveness (for instance, calculating network competitiveness toward a simple network in a form of independent node A or node A-node B).

### 5-9. Meaning of Formula for Measuring Network Effect and Network Competitiveness in Social Network

In society, if people communicate a competitive human network of the 1^{st} ties network and build much social capital with them, network competitiveness is increased. In the above formula 9, individual's competitiveness is affected by the number and competitiveness of the 1^{st} ties related human network, the level of interests and will among the 1^{st} ties related human network, and the level of social capital of a network, and these reflect the truth of social circumstances.

Further, people who frequently communicate people having much social capital are considered to be importance, and the above formula is a means of analyzing social network which may analyze who is an importance person in a social network.

In terms of analyzing propagation effects of particular social phenomena by a social network, the above formula 9, a means of analyzing a social network, may be also used as a means of analyzing responses and phenomena in a network if various factors such as happiness, obesity, and smoking, which have been studied in relation to a social network in recent sociology field, instead of individual's competitiveness are quantified for each node and required information is inputted to each node.

6. Network Effect, Network Competitiveness and Social Rank

As long as competitiveness possessed by each node gains network effect by mutual transfer with the n^{th} ties network via a network, each node obtains network competitiveness. If network competitiveness of each node is measured based on ^{Π}5-7. Formula for measuring network effect and network competitiveness in social network_{┘}, mentioned above, it is possible to score \textcircled{1} network effect, \textcircled{2} network competitiveness, and \textcircled{3} social rank, which is a relatively competitiveness indicator of each node in a network.

Meanwhile, the level of competitiveness for each n^{th} ties network may be estimated by comparing network effect(ne¹i, ne²i, ne³i, . . . , neⁿi) for the n^{th} ties network of each node i, and there are two kinds of \textcircled{1} socio-capitalization and \textcircled{2} total competitiveness in individual competitiveness of node i. The meanings of result values are different depending on the type of individual competitiveness and therefore, the value of a network to which an individual is joined may be estimated by comparing the network effect for the n^{th} ties network and calculation results of network competitiveness by two kinds of individual competitiveness, provided to users, as shown in Table 21.

TABLE 18

| | types | |
|---|---|---|
| | | INDIVIDUAL'S TOTAL |
| classification | SOCIAL CAPITAL | ABILITY |
| INDIVIDUAL | SOCIO- | TOTAL |
| COMPETITIVENESS | CAPITALIZATION | COMPETITIVENESS |
| NETWORK EFFECT | ne1i | ne1i |
| | ne2i | ne2i |
| | ne3i | ne3i |
| | . . . | . . . |
| NETWORK | ncⁿi | ncⁿi |
| COMPETITIVENESS | | |
| Social rank | | |

7. Case Analysis Using Calculation Method

The calculation method of network competitiveness of node i is shown in the above mathematical equation 9.

### 7-1. Case 1

### 7-1-1. Analysis Condition

Network: network of FIG. 11
n=3(calculation of network competitiveness by network effect up to nodes³)
initial competitiveness=Each node is the same as 100.
Other conditions are the same as the below table 19.

TABLE 19

| nodes | direction | transfer potential factor(α) | Social capital index |
|---|---|---|---|
| A | A→B | 5% | 100% |
| | A→C | 5% | 100% |
| | A→D | 5% | 100% |
| | A→E | 5% | 100% |
| B | B→A | 5% | 100% |
| C | C→A | 5% | 100% |
| D | D→A | 5% | 100% |
| E | E→A | 5% | 100% |
| | E→F | 5% | 100% |
| F | F→E | 5% | 100% |

### 7-1-2. Analysis Results

Network effect and network competitiveness for each node are shown in the below table 20. In case that social capital is constantly accumulated for each tie, it can be seen that network effect is reflected depending on the number of human networks and competitiveness is changed.

TABLE 20

| | node | | | | | | |
|---|---|---|---|---|---|---|---|
| | A | B | C | D | E | F | [symbol] |
| individual | 100.⁰⁰⁰⁰ | 100.⁰⁰⁰⁰ | 100.⁰⁰⁰⁰ | 100.⁰⁰⁰⁰ | 100.⁰⁰⁰⁰ | 100.⁰⁰⁰⁰ | 600.⁰⁰⁰⁰ |
| competitiveness | | | | | | | |
| 1^{st} network effect | 20.⁰⁰⁰⁰ | 5.⁰⁰⁰⁰ | 5.⁰⁰⁰⁰ | 5.⁰⁰⁰⁰ | 10.⁰⁰⁰⁰ | 5.⁰⁰⁰⁰ | 50.⁰⁰⁰⁰ |
| % | 20.00% | 5.00% | 5.00% | 5.00% | 10.00% | 5.00% | 8.33% |
| 2^{nd} network effect | 0.²⁵⁰⁰ | 0.⁷⁵⁰⁰ | 0.⁷⁵⁰⁰ | 0.⁷⁵⁰⁰ | 0.⁷⁵⁰⁰ | 0.²⁵⁰⁰ | 3.⁵⁰⁰⁰ |
| % | 0.25% | 0.75% | 0.75% | 0.75% | 0.75% | 0.25% | 0.58% |
| 3^{rd} network effect | 0.⁰⁰⁰⁰ | 0.⁰¹²⁵ | 0.⁰¹²⁵ | 0.⁰¹²⁵ | 0.⁰⁰⁰⁰ | 0.⁰³⁷⁵ | 0.⁰⁷⁵⁰ |
| % | 0.00% | 0.01% | 0.01% | 0.01% | 0.00% | 0.04% | 0.01% |
| network | 120.⁴⁵²⁵ | 105.⁸²⁰⁰ | 105.⁸²⁰⁰ | 105.⁸²⁰⁰ | 110.⁸⁵⁷⁵ | 105.³⁴⁰⁰ | 653.⁶⁶⁴² |
| competitiveness | | | | | | | |
| total network effect | 20.45% | 5.82% | 5.82% | 5.82% | 10.86% | 5.34% | 8.94% |

\textcircled{1} The 1^{st} network effect(ne¹i of the mathematical equation 8) is shown in the below table 21.

TABLE 21

| | types | | | | | |
|---|---|---|---|---|---|---|
| | 1^{st} nodes | | | | | |
| | | | | Individual | | |
| nodes | direction | index | α | competitiveness | 1^{st} ne | total |
| A | ←B | 100% | 5% | 100.⁰⁰⁰⁰ | 5.⁰⁰⁰⁰ | 20.⁰⁰⁰⁰ |
| | ←C | 100% | 5% | 100.⁰⁰⁰⁰ | 5.⁰⁰⁰⁰ | |
| | ←D | 100% | 5% | 100.⁰⁰⁰⁰ | 5.⁰⁰⁰⁰ | |
| | ←E | 100% | 5% | 100.⁰⁰⁰⁰ | 5.⁰⁰⁰⁰ | |
| B | ←A | 100% | 5% | 100.⁰⁰⁰⁰ | 5.⁰⁰⁰⁰ | 5.⁰⁰⁰⁰ |
| C | ←A | 100% | 5% | 100.⁰⁰⁰⁰ | 5.⁰⁰⁰⁰ | 5.⁰⁰⁰⁰ |
| D | ←A | 100% | 5% | 100.⁰⁰⁰⁰ | 5.⁰⁰⁰⁰ | 5.⁰⁰⁰⁰ |
| E | ←A | 100% | 5% | 100.⁰⁰⁰⁰ | 5.⁰⁰⁰⁰ | 10.⁰⁰⁰⁰ |
| | ←F | 100% | 5% | 100.⁰⁰⁰⁰ | 5.⁰⁰⁰⁰ | |
| F | ←E | 100% | 5% | 100.⁰⁰⁰⁰ | 5.⁰⁰⁰⁰ | 5.⁰⁰⁰⁰ |
| total | | | | | 50.⁰⁰⁰⁰ | 50.⁰⁰⁰⁰ |

\textcircled{2} the 2^{nd} network effect(ne²i of the mathematical equation 8) is shown in the below table 22.

TABLE 22

| | types | | | | | | | | |
|---|---|---|---|---|---|---|---|---|---|
| | | | | 2^{nd} ties | | | | | |
| | 1^{st} ties | | | | | | Individual | | |
| nodes | direction | index | α | direction | index | α | competitiveness | 2^{nd} ne | total |
| A | ←E | 100% | 5% | ←F | 100% | 5% | 100.⁰⁰⁰⁰ | 0.²⁵⁰⁰ | 0.²⁵⁰⁰ |
| B | ←A | 100% | 5% | ←C | 100% | 5% | 100.⁰⁰⁰⁰ | 0.²⁵⁰⁰ | 0.⁷⁵⁰⁰ |
| | ←A | 100% | 5% | ←D | 100% | 5% | 100.⁰⁰⁰⁰ | 0.²⁵⁰⁰ | |
| | ←A | 100% | 5% | ←E | 100% | 5% | 100.⁰⁰⁰⁰ | 0.²⁵⁰⁰ | |
| C | ←A | 100% | 5% | ←B | 100% | 5% | 100.⁰⁰⁰⁰ | 0.²⁵⁰⁰ | 0.⁷⁵⁰⁰ |
| | ←A | 100% | 5% | ←D | 100% | 5% | 100.⁰⁰⁰⁰ | 0.²⁵⁰⁰ | |
| | ←A | 100% | 5% | ←E | 100% | 5% | 100.⁰⁰⁰⁰ | 0.²⁵⁰⁰ | |
| D | ←A | 100% | 5% | ←B | 100% | 5% | 100.⁰⁰⁰⁰ | 0.²⁵⁰⁰ | 0.⁷⁵⁰⁰ |
| | ←A | 100% | 5% | ←C | 100% | 5% | 100.⁰⁰⁰⁰ | 0.²⁵⁰⁰ | |
| | ←A | 100% | 5% | ←E | 100% | 5% | 100.⁰⁰⁰⁰ | 0.²⁵⁰⁰ | |
| E | ←A | 100% | 5% | ←B | 100% | 5% | 100.⁰⁰⁰⁰ | 0.²⁵⁰⁰ | 0.⁷⁵⁰⁰ |
| | ←A | 100% | 5% | ←C | 100% | 5% | 100.⁰⁰⁰⁰ | 0.²⁵⁰⁰ | |
| | ←A | 100% | 5% | ←D | 100% | 5% | 100.⁰⁰⁰⁰ | 0.²⁵⁰⁰ | |
| F | ←E | 100% | 5% | ←A | 100% | 5% | 100.⁰⁰⁰⁰ | 0.²⁵⁰⁰ | 0.²⁵⁰⁰ |
| total | | | | | | | | 3.⁵⁰⁰⁰ | 3.⁵⁰⁰⁰ |

\textcircled{3} The 3^{rd} network effect (ne³i of the mathematical equation 8) is shown in the below table 23.

TABLE 23

| | types | | | | | | | | | | | |
|---|---|---|---|---|---|---|---|---|---|---|---|---|
| | | | | | | | 3^{rd} ties | | | | | |
| | 1^{st} ties | | | 2^{nd} ties | | | | | | Individual | | |
| nodes | direction | index | α | direction | index | α | direction | index | α | competitiveness | 3^{rd} ne | total |
| B | ←A | 100% | 5% | ←E | 100% | 5% | ←F | 100% | 5% | 100.⁰⁰⁰⁰ | 0.⁰¹²⁵ | 0.⁰¹²⁵ |
| C | ←A | 100% | 5% | ←E | 100% | 5% | ←F | 100% | 5% | 100.⁰⁰⁰⁰ | 0.⁰¹²⁵ | 0.⁰¹²⁵ |
| D | ←A | 100% | 5% | ←E | 100% | 5% | ←F | 100% | 5% | 100.⁰⁰⁰⁰ | 0.⁰¹²⁵ | 0.⁰¹²⁵ |
| F | ←E | 100% | 5% | ←A | 100% | 5% | ←B | 100% | 5% | 100.⁰⁰⁰⁰ | 0.⁰¹²⁵ | 0.⁰³⁷⁵ |
| | ←E | 100% | 5% | ←A | 100% | 5% | ←C | 100% | 5% | 100.⁰⁰⁰⁰ | 0.⁰¹²⁵ | |
| | ←E | 100% | 5% | ←A | 100% | 5% | ←D | 100% | 5% | 100.⁰⁰⁰⁰ | 0.⁰¹²⁵ | |
| total | | | | | | | | | | | 0.⁰⁷⁵⁰ | 0.⁰⁷⁵⁰ |

### 7-2. Case 2

### 7-2-1. Analysis Condition

Network: network of FIG. 11
n=3(calculation of network competitiveness by network effect up to nodes³)
initial competitiveness=Each node is the same as 100.
Other conditions are the same as the below table 24.

TABLE 24

| | | | social capital |
|---|---|---|---|
| nodes | direction | transfer potential factor(α) | evaluation index |
| A | A→B | 10% | 100% |
| | A→C | 10% | 100% |
| | A→D | 10% | 100% |
| | A→E | 10% | 100% |
| B | B→A | 2% | 20% |
| C | C→A | 2% | 20% |
| D | D→A | 2% | 20% |
| E | E→A | 2% | 20% |
| | E→F | 10% | 100% |
| F | F→E | 10% | 100% |

### 7-2-2. Analysis Results

The network effect and the network competitiveness for each node are shown in the below table 25. In case that social capital is constantly accumulated for each tie, it can be seen that as for node A, the network effect is decreased and the least network competitiveness is measured due to that node A does not accumulate much social capital in spite of large-sized human network. On the contrary, it can be seen that the node E that owns large-scale social capital in spite of small-sized human networks can obtain the largest network competitiveness.

TABLE 25

| | node | | | | | | |
|---|---|---|---|---|---|---|---|
| | A | B | C | D | E | F | total |
| individual | 100.⁰⁰⁰⁰ | 100.⁰⁰⁰⁰ | 100.⁰⁰⁰⁰ | 100.⁰⁰⁰⁰ | 100.⁰⁰⁰⁰ | 100.⁰⁰⁰⁰ | 600.⁰⁰⁰⁰ |
| competitiveness | | | | | | | |
| 1^{st} network effect | 1.⁰⁰⁰⁰ | 10.⁰⁰⁰⁰ | 10.⁰⁰⁰⁰ | 10.⁰⁰⁰⁰ | 20.⁰⁰⁰⁰ | 10.⁰⁰⁰⁰ | 61.⁶⁰⁰⁰ |
| % | 1.60% | 10.00% | 10.00% | 10.00% | 20.00% | 10.00% | 10.27% |
| 2^{nd} network effect | 0.⁰⁴⁰⁰ | 0.¹²⁰⁰ | 0.¹²⁰⁰ | 0.¹²⁰⁰ | 0.¹²⁰⁰ | 1.⁰⁰⁰⁰ | 1.⁵²⁰⁰ |
| % | 0.04% | 0.12% | 0.12% | 0.12% | 0.12% | 1.00% | 0.25% |
| 3^{rd} network effect | 0.⁰⁰⁰⁰ | 0.⁰⁰⁴⁰ | 0.⁰⁰⁴⁰ | 0.⁰⁰⁴⁰ | 0.⁰⁰⁰⁰ | 0.⁰¹²⁰ | 0.⁰²⁴⁰ |
| % | 0.00% | 0.00% | 0.00% | 0.00% | 0.00% | 0.01% | 0.00% |
| network | 101.⁶⁵⁶⁴ | 110.²²⁵² | 110.²²⁵² | 110.²²⁵² | 120.³²¹² | 111.¹²²⁰ | 663.²⁴⁹² |
| competitiveness | | | | | | | |
| total network effect | 1.66% | 10.23% | 10.23% | 10.23% | 20.32% | 11.12% | 10.54% |

\textcircled{1} The 1^{st} network effect(ne¹i of the mathematical equation 8) is shown in the below table 26.

TABLE 26

| | types | | | | | |
|---|---|---|---|---|---|---|
| | 1^{st} nodes | | | | | |
| | | | | Individual | | |
| nodes | direction | index | α | competitiveness | 1^{st} ne | total |
| A | ←B | 20% | 2% | 100.⁰⁰⁰⁰ | 0.⁴⁰⁰⁰ | 1.⁶⁰⁰⁰ |
| | ←C | 20% | 2% | 100.⁰⁰⁰⁰ | 0.⁴⁰⁰⁰ | |
| | ←D | 20% | 2% | 100.⁰⁰⁰⁰ | 0.⁴⁰⁰⁰ | |
| | ←E | 20% | 2% | 100.⁰⁰⁰⁰ | 0.⁴⁰⁰⁰ | |
| B | ←A | 100% | 10% | 100.⁰⁰⁰⁰ | 10.⁰⁰⁰⁰ | 10.⁰⁰⁰⁰ |
| C | ←A | 100% | 10% | 100.⁰⁰⁰⁰ | 10.⁰⁰⁰⁰ | 10.⁰⁰⁰⁰ |
| D | ←A | 100% | 10% | 100.⁰⁰⁰⁰ | 10.⁰⁰⁰⁰ | 10.⁰⁰⁰⁰ |
| E | ←A | 100% | 10% | 100.⁰⁰⁰⁰ | 10.⁰⁰⁰⁰ | 20.⁰⁰⁰⁰ |
| | ←F | 100% | 10% | 100.⁰⁰⁰⁰ | 10.⁰⁰⁰⁰ | |
| F | ←E | 100% | 10% | 100.⁰⁰⁰⁰ | 10.⁰⁰⁰⁰ | 10.⁰⁰⁰⁰ |
| total | | | | | 61.⁶⁰⁰⁰ | 61.⁶⁰⁰⁰ |

\textcircled{2} The 2^{nd} network effect(ne²i of the mathematical equation 8) is shown in the below table 27.

TABLE 27

| | types | | | | | | | | |
|---|---|---|---|---|---|---|---|---|---|
| | | | | 2^{nd} ties | | | | | |
| | 1^{st} ties | | | | | | Individual | | |
| nodes | direction | index | α | direction | index | α | competitiveness | 2^{nd} ne | total |
| A | ←E | 20% | 2% | ←F | 100% | 10% | 100.⁰⁰⁰⁰ | 0.⁰⁴⁰⁰ | 0.⁰⁴⁰⁰ |
| B | ←A | 100% | 10% | ←C | 20% | 2% | 100.⁰⁰⁰⁰ | 0.⁰⁴⁰⁰ | 0.¹²⁰⁰ |
| | ←A | 100% | 10% | ←D | 20% | 2% | 100.⁰⁰⁰⁰ | 0.⁰⁴⁰⁰ | |
| | ←A | 100% | 10% | ←E | 20% | 2% | 100.⁰⁰⁰⁰ | 0.⁰⁴⁰⁰ | |
| C | ←A | 100% | 10% | ←B | 20% | 2% | 100.⁰⁰⁰⁰ | 0.⁰⁴⁰⁰ | 0.¹²⁰⁰ |
| | ←A | 100% | 10% | ←D | 20% | 2% | 100.⁰⁰⁰⁰ | 0.⁰⁴⁰⁰ | |
| | ←A | 100% | 10% | ←E | 20% | 2% | 100.⁰⁰⁰⁰ | 0.⁰⁴⁰⁰ | |
| D | ←A | 100% | 10% | ←B | 20% | 2% | 100.⁰⁰⁰⁰ | 0.⁰⁴⁰⁰ | 0.¹²⁰⁰ |
| | ←A | 100% | 10% | ←C | 20% | 2% | 100.⁰⁰⁰⁰ | 0.⁰⁴⁰⁰ | |
| | ←A | 100% | 10% | ←E | 20% | 2% | 100.⁰⁰⁰⁰ | 0.⁰⁴⁰⁰ | |
| E | ←A | 100% | 10% | ←B | 20% | 2% | 100.⁰⁰⁰⁰ | 0.⁰⁴⁰⁰ | 0.¹²⁰⁰ |
| | ←A | 100% | 10% | ←C | 20% | 2% | 100.⁰⁰⁰⁰ | 0.⁰⁴⁰⁰ | |
| | ←A | 100% | 10% | ←D | 20% | 2% | 100.⁰⁰⁰⁰ | 0.⁰⁴⁰⁰ | |
| F | ←E | 100% | 10% | ←A | 100% | 10% | 100.⁰⁰⁰⁰ | 1.⁰⁰⁰⁰ | 1.⁰⁰⁰⁰ |
| total | | | | | | | | 1.⁵²⁰⁰ | 1.⁵²⁰⁰ |

\textcircled{3} The 3^{rd} network effect(ne³i of the mathematical equation 8) is shown in the below table 28.

TABLE 28

| | types | | | | | | | | | | | |
|---|---|---|---|---|---|---|---|---|---|---|---|---|
| | | | | | | | 3^{rd} ties | | | | | |
| | 1^{st} ties | | | 2^{nd} ties | | | | | | Individual | | |
| nodes | direction | index | α | direction | index | α | direction | index | α | competitiveness | 3^{rd} ne | total |
| B | ←A | 100% | 10% | ←E | 20% | 2% | ←F | 100% | 10% | 100.⁰⁰⁰⁰ | 0.⁰⁰⁴⁰ | 0.⁰⁰⁴⁰ |
| C | ←A | 100% | 10% | ←E | 20% | 2% | ←F | 100% | 10% | 100.⁰⁰⁰⁰ | 0.⁰⁰⁴⁰ | 0.⁰⁰⁴⁰ |
| D | ←A | 100% | 10% | ←E | 20% | 2% | ←F | 100% | 10% | 100.⁰⁰⁰⁰ | 0.⁰⁰⁴⁰ | 0.⁰⁰⁴⁰ |
| F | ←E | 100% | 10% | ←A | 100% | 10% | ←B | 20% | 2% | 100.⁰⁰⁰⁰ | 0.⁰⁰⁴⁰ | 0.⁰¹²⁰ |
| | ←E | 100% | 10% | ←A | 100% | 10% | ←C | 20% | 2% | 100.⁰⁰⁰⁰ | 0.⁰⁰⁴⁰ | |
| | ←E | 100% | 10% | ←A | 100% | 10% | ←D | 20% | 2% | 100.⁰⁰⁰⁰ | 0.⁰⁰⁴⁰ | |
| total | | | | | | | | | | | 0.⁰²⁴⁰ | 0.⁰²⁴⁰ |

### 7-3. Case 3

### 7-3-1. Analysis Condition

Network: network of FIG. 11
n=3(calculation of network competitiveness by network effect up to nodes³)
initial competitiveness: socio-capitalization of each node

Other conditions are the same as the below table 29.

TABLE 29

| | | transfer potential | |
|---|---|---|---|
| nodes | direction | factor(α) | social capital evaluation index |
| A | A→B | 10% | 100% |
| | A→C | 10% | 100% |
| | A→D | 10% | 100% |
| | A→E | 10% | 100% |
| B | B→A | 10% | 100% |
| C | C→A | 10% | 100% |
| D | D→A | 10% | 100% |
| E | E→A | 2% | 20% |
| | E→F | 2% | 20% |
| F | F→E | 10% | 100% |

### 7-3-2. Analysis Results

Network effect and network competitiveness for each node are shown in the below Table 30. As for node A, although it has the largest individual competitiveness(socio-capitalization) due to four kinds of human network and much social capital with them, individual competitiveness of four kinds of the 1^{st} ties related human network is low and “transfer potential factor” and “social capital evaluation index” of the 1^{st} ties related node E are low. Therefore, it can be seen that network effect of node A is low.

As for the 1^{st} ties related B, C and D, they have the largest network effect because node A, having high competitiveness, has high transfer potential factor and high social capital evaluation index. As for node E, which is a non-member with large social capital, although it has only two kinds of human network, it is related to the 1^{st} ties related human network of node A, having high competitiveness. Therefore, it can be seen that its network competitiveness by network effect is extremely high.

As for node F, it has one non-member and transfer potential factor and social capital evaluation index are low. Therefore, it can be seen that network effect is low.

TABLE 30

| | node | | | | | | |
|---|---|---|---|---|---|---|---|
| | A | B | C | D | E | F | [symbol] |
| individual | 360.⁰⁰⁰⁰ | 100.⁰⁰⁰⁰ | 100.⁰⁰⁰⁰ | 100.⁰⁰⁰⁰ | 120.⁰⁰⁰⁰ | 60.⁰⁰⁰⁰ | 840.⁰⁰⁰⁰ |
| competitiveness | | | | | | | |
| 1^{st} network effect | 30.⁴⁸⁰⁰ | 36.⁰⁰⁰⁰ | 36.⁰⁰⁰⁰ | 36.⁰⁰⁰⁰ | 42.⁰⁰⁰⁰ | 0.⁴⁸⁰⁰ | 180.⁹⁶⁰⁰ |
| % | 8.47% | 36.00% | 36.00% | 36.00% | 35.00% | 0.80% | 21.54% |
| 2^{nd} network effect | 0.⁰²⁴⁰ | 2.⁰⁴⁸⁰ | 2.⁰⁴⁸⁰ | 2.⁰⁴⁸⁰ | 3.⁰⁰⁰⁰ | 0.¹⁴⁴⁰ | 9.³¹²⁰ |
| % | 0.01% | 2.05% | 2.05% | 2.05% | 2.50% | 0.24% | 1.11% |
| 3^{rd} network effect | 0.⁰⁰⁰⁰ | 0.⁰⁰²⁴ | 0.⁰⁰²⁴ | 0.⁰⁰²⁴ | 0.⁰⁰⁰⁰ | 0.⁰¹²⁰ | 0.⁰¹⁹² |
| % | 0.00% | 0.00% | 0.00% | 0.00% | 0.00% | 0.02% | 0.00% |
| network | 390.⁵⁸⁸⁷ | 138.⁴³⁰⁹ | 138.⁴³⁰⁹ | 138.⁴³⁰⁹ | 165.³⁷⁵⁰ | 60.⁶⁴⁶⁴ | 1030.⁵¹⁷⁷ |
| competitiveness | | | | | | | |
| total network effect | 8.50% | 38.43% | 38.43% | 38.43% | 37.81% | 1.08% | 22.68% |

\textcircled{1} The 1^{st} network effect(ne¹i of the mathematical equation 8) is shown in the below table 31.

TABLE 31

| | types | | | | | |
|---|---|---|---|---|---|---|
| | 1^{st} nodes | | | | | |
| | | | | Individual | | |
| nodes | direction | index | α | competitiveness | 1^{st} ne | Total |
| A | ←B | 100% | 10% | 100.⁰⁰⁰⁰ | 10.⁰⁰⁰⁰ | 30.⁴⁸⁰⁰ |
| | ←C | 100% | 10% | 100.⁰⁰⁰⁰ | 10.⁰⁰⁰⁰ | |
| | ←D | 100% | 10% | 100.⁰⁰⁰⁰ | 10.⁰⁰⁰⁰ | |
| | ←E | 20% | 2% | 120.⁰⁰⁰⁰ | 0.⁴⁸⁰⁰ | |
| B | ←A | 100% | 10% | 360.⁰⁰⁰⁰ | 36.⁰⁰⁰⁰ | 36.⁰⁰⁰⁰ |
| C | ←A | 100% | 10% | 360.⁰⁰⁰⁰ | 36.⁰⁰⁰⁰ | 36.⁰⁰⁰⁰ |
| D | ←A | 100% | 10% | 360.⁰⁰⁰⁰ | 36.⁰⁰⁰⁰ | 36.⁰⁰⁰⁰ |
| E | ←A | 100% | 10% | 360.⁰⁰⁰⁰ | 36.⁰⁰⁰⁰ | 42.⁰⁰⁰⁰ |
| | ←F | 100% | 10% | 60.⁰⁰⁰⁰ | 6.⁰⁰⁰⁰ | |
| F | ←E | 20% | 2% | 120.⁰⁰⁰⁰ | 0.⁴⁸⁰⁰ | 0.⁴⁸⁰⁰ |
| total | | | | | 180.⁹⁶⁰⁰ | 180.⁹⁶⁰⁰ |

\textcircled{2} The 2^{nd} network effect(ne²i of the mathematical equation 8) is shown in the below table 32.

TABLE 32

| | types | | | | | | | | |
|---|---|---|---|---|---|---|---|---|---|
| | | | | 2^{nd} ties | | | | | |
| | 1^{st} ties | | | | | | Individual | | |
| nodes | direction | index | α | direction | index | α | competitiveness | 2^{nd} ne | total |
| A | ←E | 20% | 2% | ←F | 100% | 10% | 60.⁰⁰⁰⁰ | 0.⁰²⁴⁰ | 0.⁰²⁴⁰ |
| B | ←A | 100% | 10% | ←C | 100% | 10% | 100.⁰⁰⁰⁰ | 1.⁰⁰⁰⁰ | 2.⁰⁴⁸⁰ |
| | ←A | 100% | 10% | ←D | 100% | 10% | 100.⁰⁰⁰⁰ | 1.⁰⁰⁰⁰ | |
| | ←A | 100% | 10% | ←E | 20% | 2% | 120.⁰⁰⁰⁰ | 0.⁰⁴⁸⁰ | |
| C | ←A | 100% | 10% | ←B | 100% | 10% | 100.⁰⁰⁰⁰ | 1.⁰⁰⁰⁰ | 2.⁰⁴⁸⁰ |
| | ←A | 100% | 10% | ←D | 100% | 10% | 100.⁰⁰⁰⁰ | 1.⁰⁰⁰⁰ | |
| | ←A | 100% | 10% | ←E | 20% | 2% | 120.⁰⁰⁰⁰ | 0.⁰⁴⁸⁰ | |
| D | ←A | 100% | 10% | ←B | 100% | 10% | 100.⁰⁰⁰⁰ | 1.⁰⁰⁰⁰ | 2.⁰⁴⁸⁰ |
| | ←A | 100% | 10% | ←C | 100% | 10% | 100.⁰⁰⁰⁰ | 1.⁰⁰⁰⁰ | |
| | ←A | 100% | 10% | ←E | 20% | 2% | 120.⁰⁰⁰⁰ | 0.⁰⁴⁸⁰ | |
| E | ←A | 100% | 10% | ←B | 100% | 10% | 100.⁰⁰⁰⁰ | 1.⁰⁰⁰⁰ | 3.⁰⁰⁰⁰ |
| | ←A | 100% | 10% | ←C | 100% | 10% | 100.⁰⁰⁰⁰ | 1.⁰⁰⁰⁰ | |
| | ←A | 100% | 10% | ←D | 100% | 10% | 100.⁰⁰⁰⁰ | 1.⁰⁰⁰⁰ | |
| F | ←E | 20% | 2% | ←A | 100% | 10% | 360.⁰⁰⁰⁰ | 0.¹⁴⁴⁰ | 0.¹⁴⁴⁰ |
| total | | | | | | | | 9.³¹²⁰ | 9.³¹²⁰ |

\textcircled{3} The 3^{rd} network effect(ne³i of the mathematical equation 8) is shown in the below table 33.

TABLE 33

| | types | | | | | | | | | | | |
|---|---|---|---|---|---|---|---|---|---|---|---|---|
| | | | | | | | 3^{rd} ties | | | | | |
| | 1^{st} ties | | | 2^{nd} ties | | | | | | Individual | | |
| nodes | direction | index | α | direction | index | α | direction | index | α | competitiveness | 3^{rd} ne | total |
| B | ←A | 100% | 10% | ←E | 20% | 2% | ←F | 100% | 10% | 60.⁰⁰⁰⁰ | 0.⁰⁰²⁴ | 0.⁰⁰²⁴ |
| C | ←A | 100% | 10% | ←E | 20% | 2% | ←F | 100% | 10% | 60.⁰⁰⁰⁰ | 0.⁰⁰²⁴ | 0.⁰⁰²⁴ |
| D | ←A | 100% | 10% | ←E | 20% | 2% | ←F | 100% | 10% | 60.⁰⁰⁰⁰ | 0.⁰⁰²⁴ | 0.⁰⁰²⁴ |
| F | ←E | 20% | 2% | ←A | 100% | 10% | ←B | 100% | 10% | 100.⁰⁰⁰⁰ | 0.⁰⁰⁴⁰ | 0.⁰¹²⁰ |
| | ←E | 20% | 2% | ←A | 100% | 10% | ←C | 100% | 10% | 100.⁰⁰⁰⁰ | 0.⁰⁰⁴⁰ | |
| | ←E | 20% | 2% | ←A | 100% | 10% | ←D | 100% | 10% | 100.⁰⁰⁰⁰ | 0.⁰⁰⁴⁰ | |
| total | | | | | | | | | | | 0.⁰¹⁹² | 0.⁰¹⁹² |

8. Analysis of Effect

### 8-1. Social Network, Competitiveness and Social Capital

Generally, when keeping a good relationship and building much social capital with people in society, individuals improve their own social competitiveness. However, as seen in FIG. 14, social competitiveness or social capital of each person in the actual offline social network is actually existed in the real social network in offline system, which is a network which seems differentiated, but invisible and unquantifiable.

Further, social costs are greatly generated in various social activities such as recruiting, business, personal exchange for the reason that competitiveness or social capital of each person is intangible and unquantifiable.

Meanwhile, according to recent researches on economics, social capital refers to third-generation capital followed by first-generation capital(physical capital) and second-generation capital(human capital), having a quite significant meaning as competitiveness between two people. Also, some sociologists insist that the rate of economic growth is increased by 0.8% when social capital index is increased by 10%.

### 8-2. Social Network of Online SNS(Social Networking Service)

Network is extended by online human network agreement in previous social networking service (SNS); as seen in FIG. 15, simple undifferentiated network is formed due to no information in nodes and ties; it comes to social problems because of the lack of truth and trust of networks; and development of services and profit structures is interrupted.

### 8-3. Embodying Real Network and Expanding Social Capital

Accordingly, the method for scoring individual network competitiveness and network effect in an online social network according to the present invention is directed to a network competitiveness analysis algorithm by social network effect, enabling to measure network effect, network competitiveness, social rank of each individual.

Further, as seen in FIG. 16, it enables to diversify services, maximize competitiveness and create profit structure by giving information value to nodes and ties of network infrastructure upon providing social networking services by the algorithm.

Furthermore, in case that services are provided to each person by measuring network effect, network competitiveness, and social rank of each individual, social costs would be decreased in various range of social activities like recruitment, business, personal exchange, etc.

Also, though one person does not improve his own competitiveness, competitiveness would be improved by network effect to which competitive human networks and various human networks related to social capital are accumulated and then, social capital, which is “space competitiveness”, is collected by needs of each person who tries to make network effect, network competitiveness and social rank higher. Therefore, it causes the decrease of social costs and economic growth by spreading social capital of the whole networks. Also, economic and sociologic research materials may be obtained through analyzing results, analyzed by the algorithm, statistically.

The present invention can be variously modified and embodied by several types of forms, and particular illustrative embodiments are merely described in the detailed description of the invention. However, it should be appreciated in such a manner that the present invention is not limited as a particular type, mentioned in the detailed description, but rather it comprises all modified materials, equal materials, and substitutes within the spirit and the range of the present invention, defined by the enclosed claims herewith.

### BRIEF DESCRIPTION OF THE DRAWINGS

FIG. 1 is a schematic drawing representing the structure of the system for scoring social capital index in an online social network.

FIG. 2 is a schematic drawing representing the structure of the system for scoring individual network competitiveness and network effect in an online social network according to the present invention.

FIGS. 3a and 3b are flow charts for explaining the method for scoring individual network competitiveness and network effect in an online social network according to the invention.

FIG. 4 is a drawing for explaining networks and social capital.

FIG. 5 is a drawing for explaining competitiveness transfer and network effect.

FIG. 6 is a drawing for explaining the relation between networks and ties.

FIG. 7 is a drawing showing an example of a network.

FIG. 8 is a drawing showing an example of increase in network effect by network competitiveness calculation.

FIGS. 9 and 10 are flow charts for explaining the calculation range of network competitiveness in the present invention.

FIG. 11 is a drawing for explaining mutual interchange of competitiveness in a network.

FIG. 12 is a drawing for explaining potential factors for ties and competitiveness transfer and capital index.

FIG. 13 is a drawing for explaining the calculation range of a network and common competitiveness.

FIG. 14 is a drawing illustrating real networks in offline system.

FIG. 15 is a drawing illustrating social networks in prior online system.

FIG. 16 is a drawing illustrating real networks in online system according to the present invention.

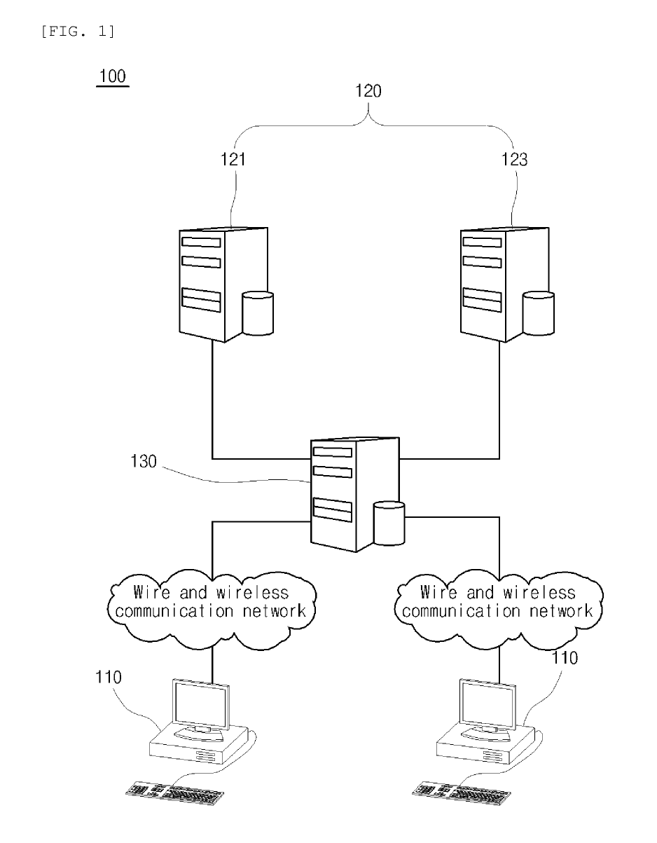

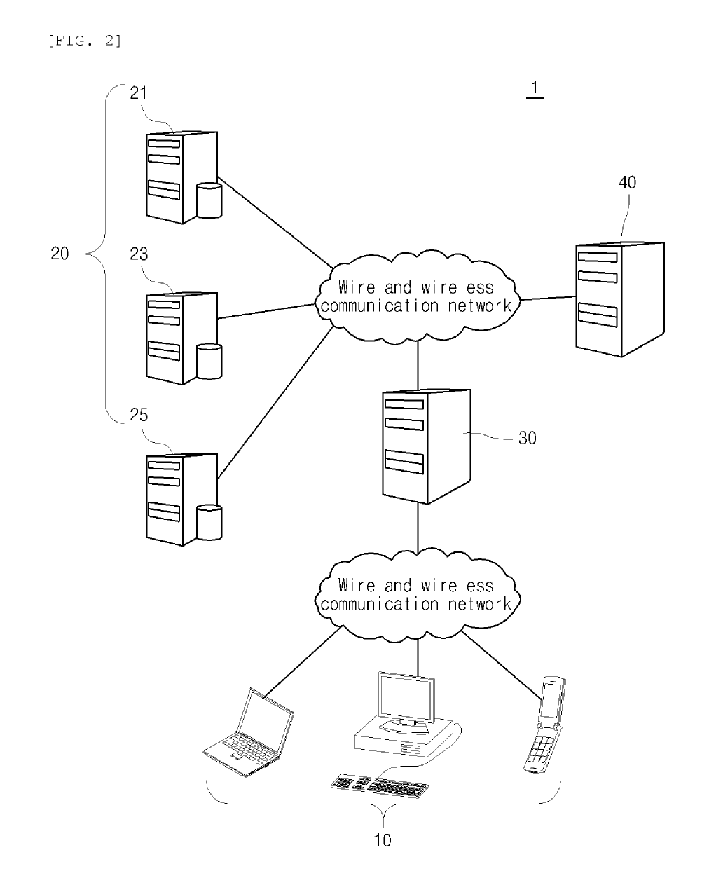

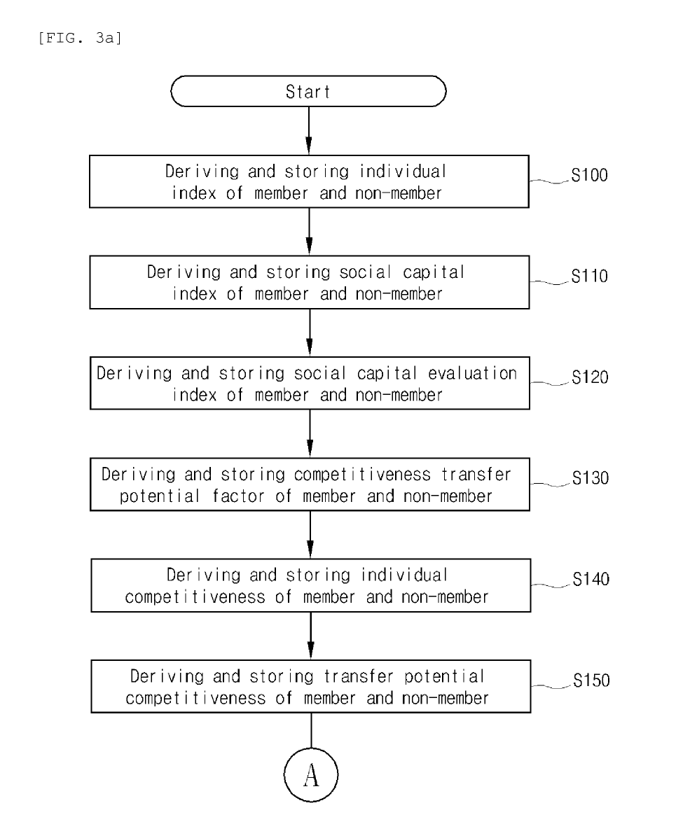

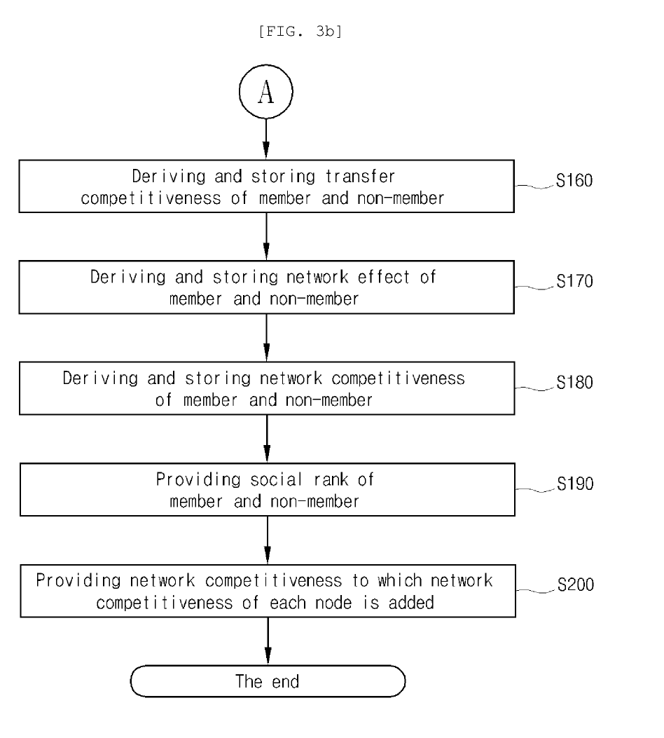

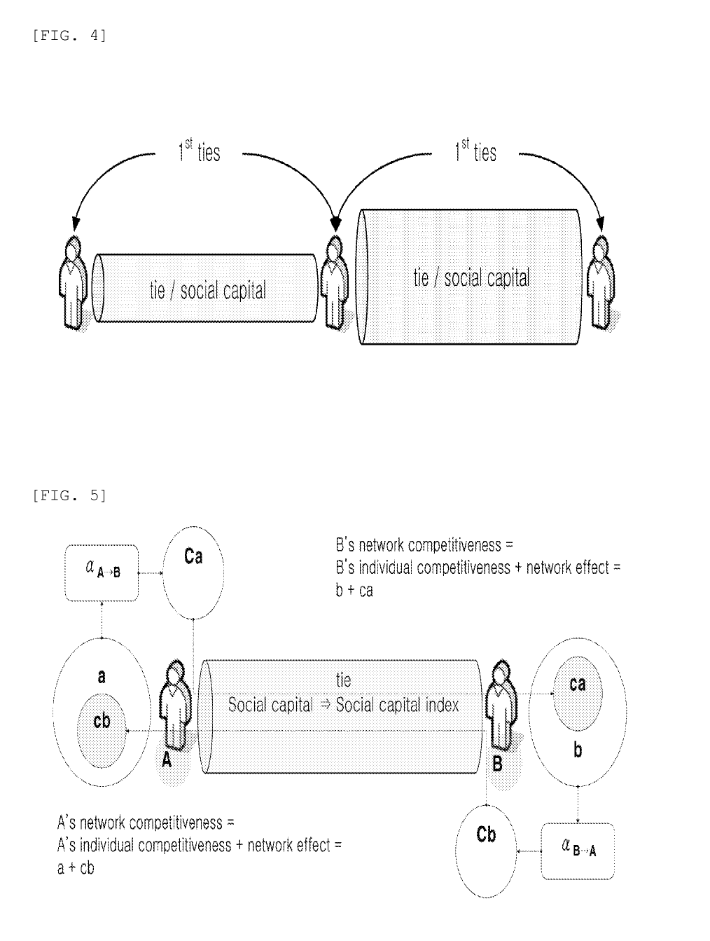

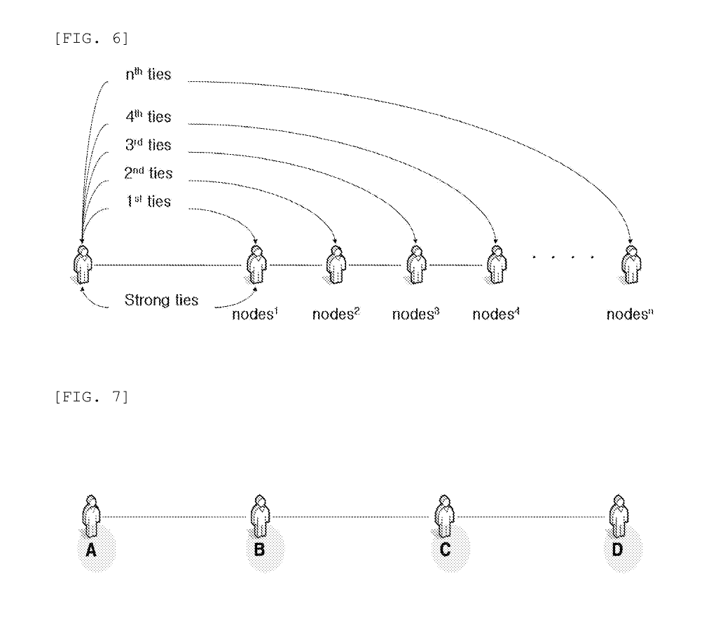

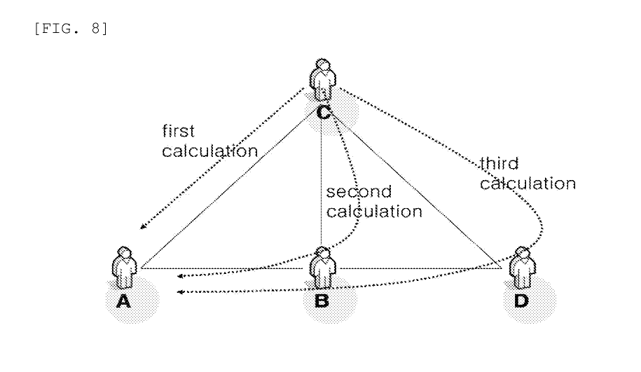

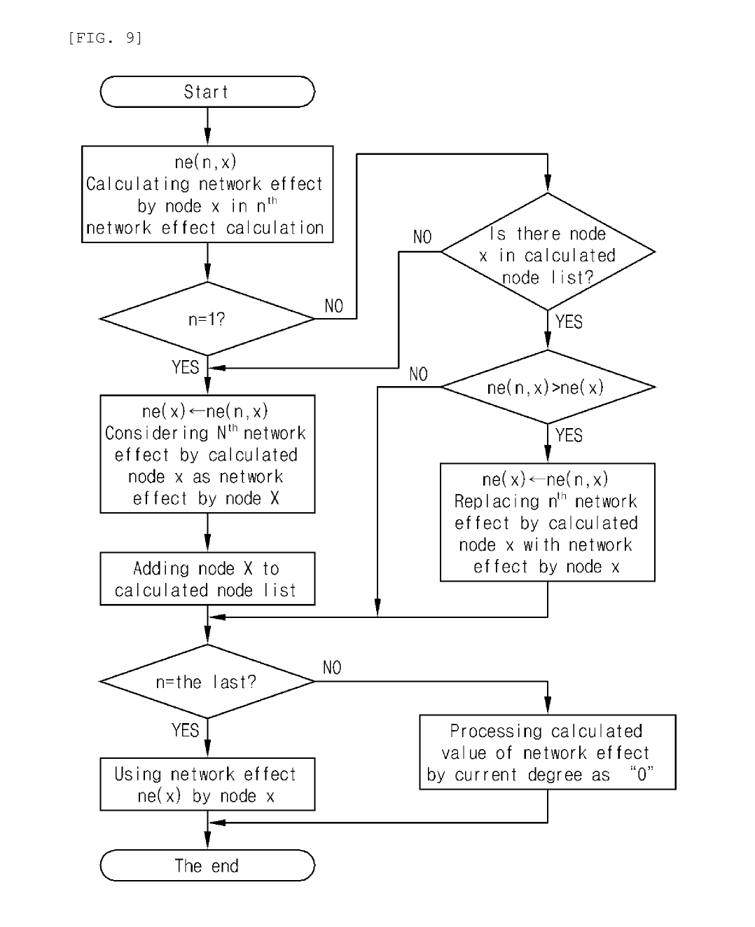

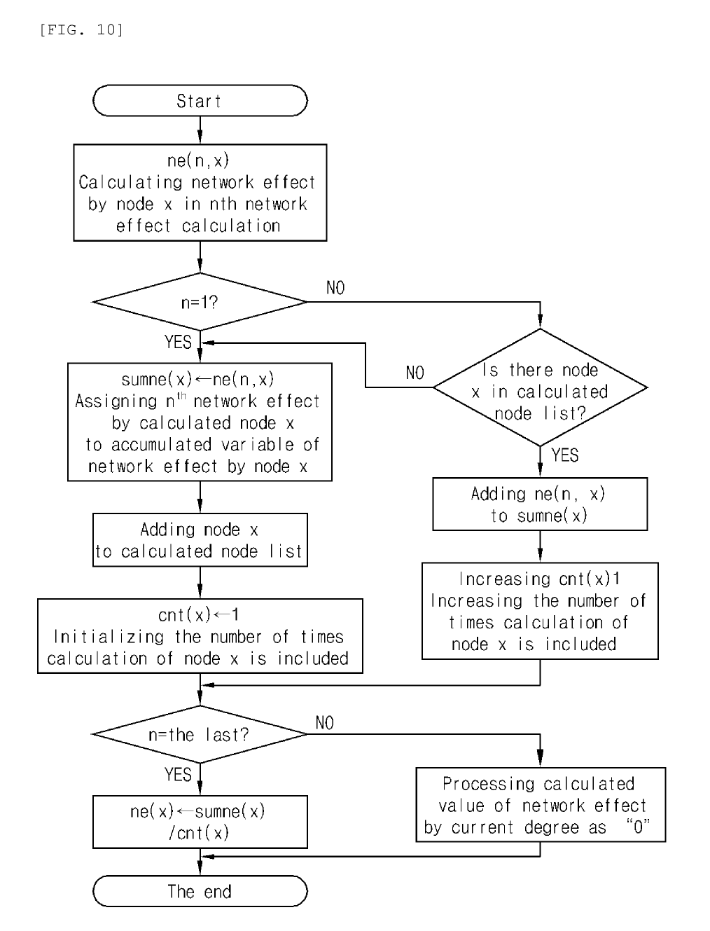

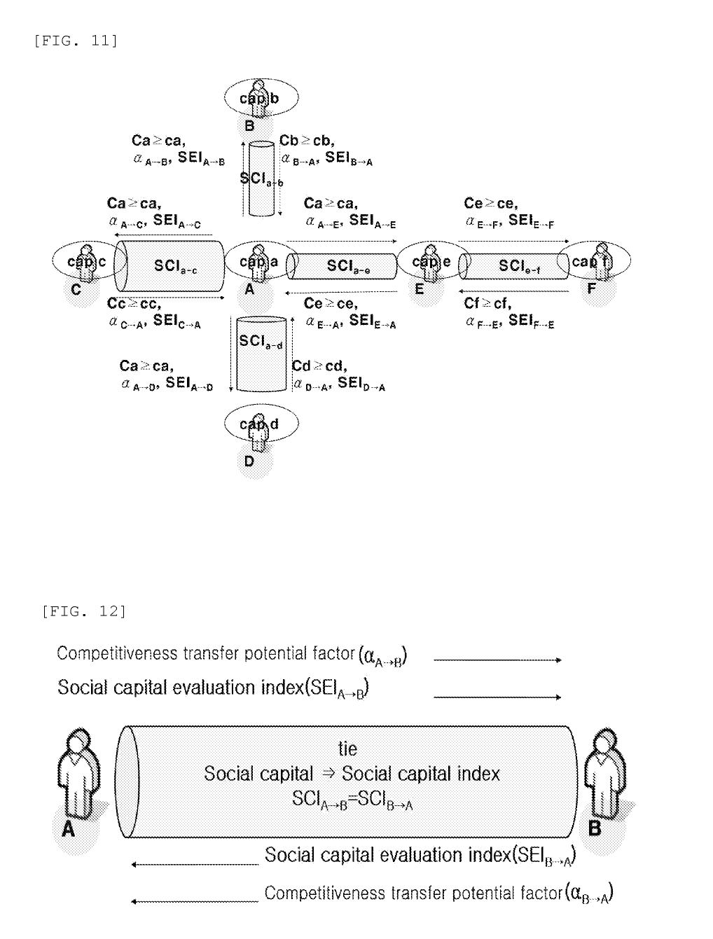

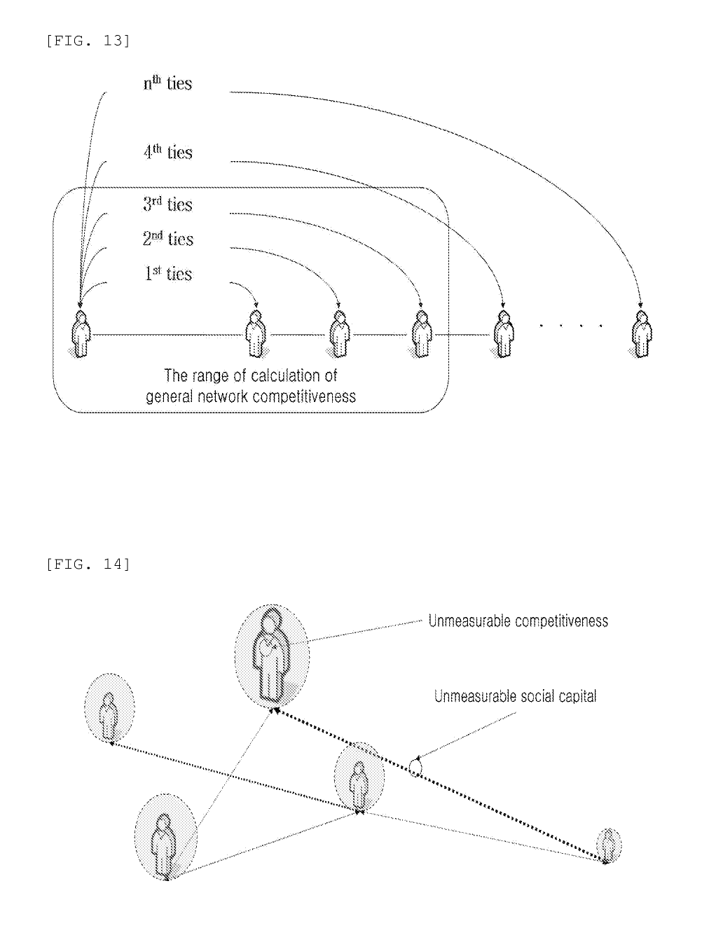

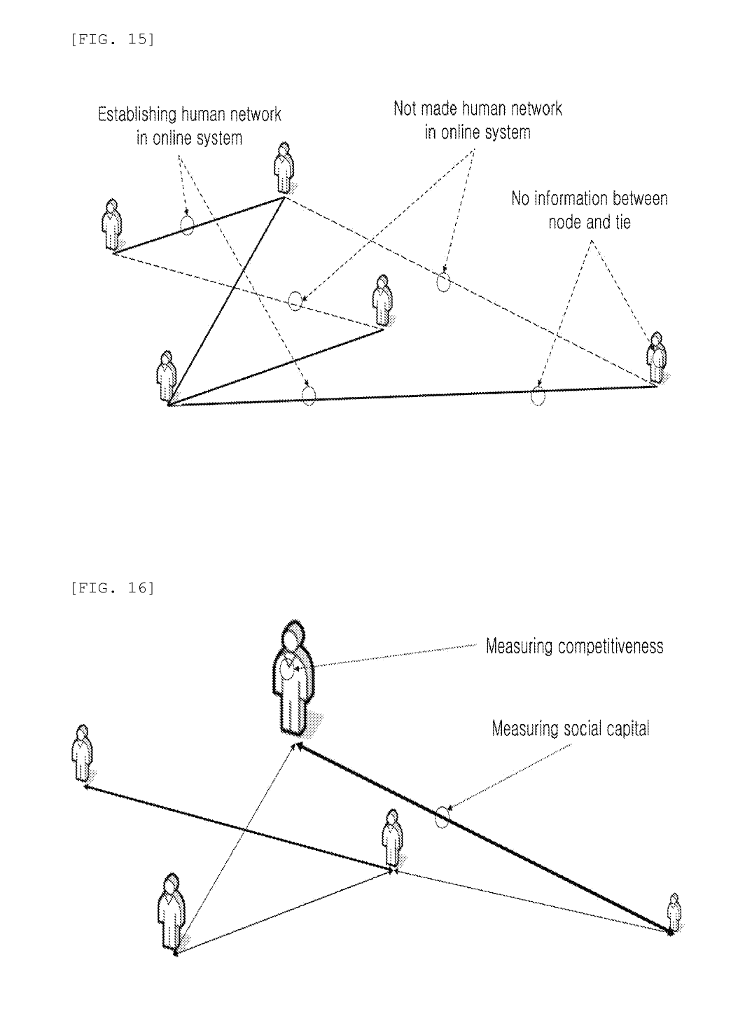

### EXPLANATIONS OF REFERENCE NUMERALS

10: client computer
20: social network database
21: member information database
23: human network information database
25: non-member information database
30: application server
40: server for analyzing network effect

### INDUSTRIAL APPLICABILITY

The method for scoring individual network competitiveness and network effect in an online social network according to the present invention may be used in various kinds of industry fields such as online target advertising for maintenance of each company's recruitment and growth, tracking the social spread of disease in the sphere of pathology, social network study in the sphere of mathematical sociology, etc. by measuring status and competitiveness of each individual.

What is claimed is:

1. A method for scoring network competitiveness and network effect of each node in an online social network based on results of mutual evaluation for trust, integrity, solidarity, openness, importance, and intimacy among 1^{st} ties related nodes in an online social network, comprising:
individual index derivation process of deriving individual indexes, which consist of trust index (TI), integrity index (II), solidarity index (SI), openness index (OI), importance index (IMI) and intimacy index (INI) quantifying the level of trust, integrity, solidarity, openness and importance among 1^{st} tie related nodes, for ties of each node by using the results of mutual evaluation;
social capital index derivation process of deriving social capital index (SCI), quantifying the level of social capital among 1^{st} ties related nodes, for ties of each node by using the results of mutual evaluation; social capital evaluation index derivation process of deriving social capital evaluation index (SEI), quantifying the level of mutual evaluation among 1^{st} ties related nodes, for ties of each node by using the results of mutual evaluation;
competitiveness transfer potential factor derivation process of deriving competitiveness transfer potential factor(α), quantifying the potential level of transferring competitiveness of 1^{st} ties related node to an arbitrary node, for ties of each node by using the level of evaluation for importance index and intimacy index among individual indexes by the results of, mutual evaluation;
individual competitiveness derivation process of deriving individual competitiveness(nc⁰i), quantifying competitiveness of each individual, for each node by using the social capital index; transfer potential competitiveness derivation process of deriving transfer potential competitiveness(Ci), quantifying the level of competitiveness transferring from a 1^{st} ties related node to an arbitrary node, for ties of each node by using the competitiveness transfer potential factor and the individual competitiveness;
transfer competitiveness derivation process of deriving transfer competitiveness(ci), quantifying competitiveness actually transferring from a 1^{st} ties related node to an arbitrary node, for ties of each node by using social capital index or social capital evaluation index, competitiveness transfer potential factor and individual competitiveness;
network effect derivation process of deriving network effect(neⁿi), quantifying competitiveness that is consecutively transferred from a 1^{st} ties related node to an arbitrary node through a network by interaction among 1^{st} ties related nodes with each node, by using the social capital index from an arbitrary node to 1^{st}˜n^{th} ties related nodes or social capital evaluation index, competitiveness transfer potential factor and individual competitiveness; and
network competitiveness derivation process of deriving competitiveness, cause by network effect of an arbitrary node, by using the social capital index from an arbitrary node to 1^{st}˜n^{th} ties related nodes or social capital evaluation index, competitiveness transfer potential factor, individual competitiveness, transfer potential competitiveness, transfer competitiveness and network effect.

2. The method for scoring network competitiveness and network effect of each node in an online social network according to claim 1, wherein the individual index is expressed in terms of trust index, integrity index, solidarity index, openness index, importance index and intimacy index, which are corresponded for each tie between an arbitrary node and a 1^{st} ties related node, by measuring the level of individual items by mutual evaluation for each item of trust, integrity, solidarity, openness, importance and intimacy among 1^{st} ties related nodes in a social network.

3. The method for scoring network competitiveness and network effect of each node in an online social network according to claim 2, wherein the mutual evaluation estimates will, ability and standards of evaluators toward evaluatees for each item of trust, integrity, solidarity, openness, importance and intimacy among 1^{st} ties related nodes in social network.

4. The method for scoring network competitiveness and network effect of each node in an online social network according to claim 1, wherein the social capital index refers to a symmetrical value which is constant for each tie between an arbitrary node and a 1^{st} ties related node, adding and calculating all individual indexes and weights after calculating each individual index by mutual evaluation for each item of individual indexes among 1^{st} ties related nodes and applying weights in a social network.

5. The method for scoring network competitiveness and network effect of each node in an online social network according to claim 1, wherein the social capital evaluation index refers to a bidirectional asymmetric value for each tie between an arbitrary node and a 1^{st} ties related node, calculating one index for each evaluator after applying weights to the level of evaluation of evaluators for each item of individual indexes among 1^{st} ties related nodes and adding weights and individual indexes in a social network.

6. The method for scoring network competitiveness and network effect of each node in an online social network according to claim 1, wherein the competitiveness transfer potential factor refers to a bidirectional asymmetric value for each tie between an arbitrary node and a 1^{st} ties related node, calculating one index for each evaluator after adding all levels of evaluation of evaluators for importance index and intimacy index among individual indexes among 1^{st} ties related nodes in a social network.

7. The method for scoring network competitiveness and network effect of each node in an online social network according to claim 1, wherein the individual competitiveness refers to socio-capitalization(cap i) adding all social capital indexes of 1^{st} ties related nodes for each node in a social network

8. The method for scoring network competitiveness and network effect of each node in an online social network according to claim 1, wherein the individual competitiveness refers to total competitiveness(tot Ci) further adding any one or more index selected among globalization index, celebrity index, social broker index to the socio-capitalization.

9. The method for scoring network competitiveness and network effect of each node in an online social network according to claim 8, wherein the globalization index, the celebrity index and the social broker index respectively refer to a value calculated by using the number and relation of nodes having other nationalities among arbitrary nodes and connected nodes; a value calculated by using the level which is estimated as celebrities by arbitrary nodes and connected nodes; and a value calculated by using the number of cases, performance and evaluation in which arbitrary nodes broker Needs of a social network.

10. The method for scoring network competitiveness and network effect of each node in an online social network according to claim 1, the transfer potential competitiveness refers to a value multiplying individual competitiveness from arbitrary nodes, object of calculation object of network competitiveness, to 1^{st} ties related nodes by competitiveness transfer potential factor whose direction is competitiveness transfer.

11. The method for scoring network competitiveness and network effect of each node in an online social network according to claim 1, the transfer competitiveness refers to a value multiplying individual competitiveness from arbitrary nodes, calculation objects of network competitiveness, to 1^{st} ties related nodes by competitiveness transfer potential factor whose direction is competitiveness transfer and multiplying this value by social capital index or social capital evaluation index whose direction is competitiveness transfer.

12. The method for scoring network competitiveness and network effect of each node in an online social network according claim 11, if the above competitiveness is transferred among 1^{st} ties related nodes in a social network, the competitiveness from arbitrary nodes, calculation objects of network competitiveness, and n^{th} ties related nodes to arbitrary nodes is finally transferred to arbitrary nodes by being consecutively transferred from n^{th} ties related nodes to n−1^{th}, n−2^{th}, . . . nodes via a shortest path; and transfer for each level is estimated by the competitiveness transfer potential factor whose direction is the competitiveness transfer, social capital index or social capital evaluation index.

13. The method for scoring network competitiveness and network effect of each node in an online social network according to claim 1, wherein the network effect is as below:
$$\begin{matrix}{ne}^{n} i = network effect by {nodes}^{n} of node i \\ = \sum {c}_{{nodes}^{n} \to i}^{n} \\ = \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times \\ \sum ( {SI}_{{nodes}^{3} \to {nodes}^{2}} ( \% ) \times {α}_{{nodes}^{3} \to {nodes}^{2}} ( \% ) \times … \times \\ \sum ( {SI}_{{nodes}^{n - 1} \to {nodes}^{n - 2}} ( \% ) \times {α}_{{nodes}^{n - 1} \to {nodes}^{n - 2}} ( \% ) \times \\ \sum ( {SI}_{{nodes}^{n} \to {nodes}^{n - 1}} ( \% ) \times {α}_{{nodes}^{n} \to {nodes}^{n - 1}} ( \% ) \times \\ {nc}^{0} {nodes}^{n} ) … )\end{matrix}$$

14. The method for scoring network competitiveness and network effect of each node in an online social network according to claim 1, wherein the network competitiveness is as below:
$$\begin{matrix}{nc}^{n} i = {nc}^{0} i + {ne}^{1} i + {ne}^{2} i + {ne}^{3} i + … + {ne}^{n} i \\ = {nc}^{0} i + \sum {c}_{{nodes}^{1} \to i}^{1} + \sum {c}_{{nodes}^{2} \to i}^{2} + \\ \sum {c}_{{nodes}^{3} \to i}^{3} + … + \sum {c}_{{nodes}^{n} \to i}^{n} \\ = {nc}^{0} i + \sum ( {SI}_{{nodes}^{1} \to i} ( \% ) \times {α}_{{nodes}^{1} \to i} ( \% ) \times {nc}^{0} {nodes}^{1} ) + \\ \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times {nc}^{0} {nodes}^{2} ) ) + \\ \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times \\ \sum ( {SI}_{{nodes}^{3} \to {nodes}^{2}} ( \% ) \times {α}_{{nodes}^{3} \to {nodes}^{2}} ( \% ) \times \\ {nc}^{0} {nodes}^{3} ) ) ) + … + \sum ( {SI}_{{nodes}^{1} \to i} ( \% ) \times {α}_{{nodes}^{1} \to i} ( \% ) \times \\ \sum ( {SI}_{{nodes}^{2} \to {nodes}^{1}} ( \% ) \times {α}_{{nodes}^{2} \to {nodes}^{1}} ( \% ) \times \\ \sum ( {SI}_{{nodes}^{3} \to {nodes}^{2}} ( \% ) \times {α}_{{nodes}^{3} \to {nodes}^{2}} ( \% ) \times … \times \\ \sum ( {SI}_{{nodes}^{n - 1} \to {nodes}^{n - 2}} ( \% ) \times {α}_{{nodes}^{n - 1} \to {nodes}^{n - 2}} ( \% ) \times \\ \sum ( {SI}_{{nodes}^{n} \to {nodes}^{n - 1}} ( \% ) \times {α}_{{nodes}^{n} \to {nodes}^{n - 1}} ( \% ) \times \\ {nc}^{0} {nodes}^{n} ) … )\end{matrix}$$

15. The method for scoring network competitiveness and network effect of each node in an online social network according to claim 1, wherein the network effect derivation process or network competitiveness derivation process is characterized in that if competitiveness of the same node is transferred and increased by expanding a path in the next degree calculation, the network effect having the lowest degree in a network is applied, and nodes already calculated in degree, below n^{th}, upon calculating n^{th} network effect are not included; the biggest network effect among all network effects is applied; and if one of applying the average of all network effect is applied or the competitiveness of the same node is transferred and increased through various paths in the same degree calculation, the biggest network effect among all network effects is applied.

16. The method for scoring network competitiveness and network effect of each node in an online social network according to claim 1, wherein the method for scoring individual network competitiveness and network effect in an online social network further comprises the process of scoring network competitiveness and network effect of member nodes and non-member nodes by non-member nodes, which is included to the social network, if a member asks a non-member for human network agreement by email and the non-member accepts the human network agreement.

17. The method for scoring network competitiveness and network effect of each node in an online social network according to claim 1, wherein the method for scoring individual network competitiveness and network effect in an online social network further comprises the social rank giving process of providing users with social rank for each node based on total members(including non-members), nation(s), school(s), work area(s), sex, age(s), social club(s), etc. through member information(including non-members), or providing users with social rank of the corresponding node based on total members, nation(s), school(s), work area(s), sex, age(s), social club(s), etc. through profile information for each node.

18. The method for scoring network competitiveness and network effect of each node in an online social network according to claim 1, wherein the method for scoring individual network competitiveness and network effect in an online social network further comprises the process of providing users with network competitiveness which all adds network competitiveness of each node for total members(including non-members), nation(s), school(s), work area(s), sex, age(s) and social club(s).
